(19) United States
(12) Patent Application Publication
(10) Pub. No.: US 2019/0206587 A1
(43) Pub. Date: Jul. 4, 2019

(54) CONDUCTIVE MATERIAL, CONNECTION STRUCTURE BODY, AND CONNECTION STRUCTURE BODY PRODUCTION METHOD

(71) Applicant: SEKISUI CHEMICAL CO., LTD., Osaka-city, Osaka (JP)

(72) Inventors: Shike Sou, Mishima-gun, Osaka (JP); Masahiro Itou, Mishima-gun, Osaka (JP); Shuujirou Sadanaga, Kouka-city, Shiga (JP)

(21) Appl. No.: 16/325,934

(22) PCT Filed: Aug. 30, 2017
(86) PCT No.: PCT/JP2017/031101

§ 371 Date: Feb. 15, 2019

(30) Foreign Application Priority Data
Sep. 9, 2016 (JP) 2016-176650

(51) Int. Cl. H01B 1/22; H01B 5/16; C08L 101/12; C08K 3/16; C09J 9/02; H01R 11/01

(52) U.S. Cl. CPC H01B 1/22; H01B 5/16; C08L 101/12; C08K 2201/001; C09J 9/02; H01R 11/01; C08K 3/16

(57) ABSTRACT

The present invention provides a conductive material in which, even when the conductive material is left for a certain period of time, solder of conductive particles can be efficiently placed on an electrode, and, in addition, yellowing of the conductive material can be sufficiently suppressed during heating. The conductive material according to the present invention contains a plurality of conductive particles having solder at an outer surface portion of a conductive portion, a curable compound, and a boron trifluoride complex.

### TECHNICAL FIELD

The present invention relates to a conductive material containing conductive particles having solder at an outer surface portion of a conductive portion. The present invention also relates to a connection structure using the conductive material and a method for producing a connection structure.

### BACKGROUND ART

Anisotropic conductive materials such as anisotropic conductive paste and anisotropic conductive films are widely known. In the anisotropic conductive material, conductive particles are dispersed in a binder resin.

The anisotropic conductive material is used to obtain various connection structures. Examples of the connection structure include a connection between a flexible printed board and a glass substrate (FOG (Film on Glass)), a connection between a semiconductor chip and a flexible printed board (COF (Chip on Film)), a connection between a semiconductor chip and a glass substrate (COG (Chip on Glass)), and a connection between a flexible printed board and a glass epoxy board (FOB (Film on Board)).

For example, when an electrode of a flexible printed board and an electrode of a glass epoxy board are electrically connected by the anisotropic conductive material, the anisotropic conductive material containing conductive particles is placed on the glass epoxy board. Then, the flexible printed board is stacked to be heated and pressurized. Thereby, the anisotropic conductive material is cured to electrically connect the electrodes via the conductive particles, and thus to obtain the connection structure.

As an example of the anisotropic conductive material, the following Patent Document 1 describes an anisotropic conductive material containing conductive particles and a resin component which is not completely cured at the melting point of the conductive particles. Specific examples of the conductive particles include metals such as tin (Sn), indium (In), bismuth (Bi), silver (Ag), copper (Cu), zinc (Zn), lead (Pb), cadmium (Cd), gallium (Ga) and thallium (Tl), and alloys of these metals.

Patent Document 1 describes that electrodes are electrically connected through a resin heating step in which an anisotropic conductive resin is heated to a temperature which is higher than the melting point of the conductive particles and at which the resin component is not completely cured, and a resin component curing step in which the resin component is cured. In addition, Patent Document 1 describes that mounting is performed according to the temperature profile shown in FIG. 8. In Patent Document 1, the conductive particles are melted in the resin component, which is not completely cured, at a temperature at which the anisotropic conductive resin is heated.

The following Patent Document 2 discloses an adhesive tape including a resin layer containing a thermosetting resin, a solder powder, and a curing agent, and in this adhesive tape, the solder powder and the curing agent reside in the resin layer. This adhesive tape is in the form of a film and is not pasty.

In addition, Patent Document 2 discloses a method of bonding using the adhesive tape. Specifically, a first substrate, an adhesive tape, a second substrate, an adhesive tape and a third substrate are stacked in this order as viewed from the bottom to obtain a stack. In this case, a first electrode provided to the surface of the first substrate and a second electrode provided to the surface of the second substrate are opposed to each other. Also a second electrode provided to the surface of the second substrate and a third electrode provided to the surface of the third substrate are opposed to each other. The stack is then bonded under heating at a predetermined temperature. Thereby, a connection structure is obtained.

The following Patent Document 3 discloses a conductive adhesive composition which contains conductive particles containing metal having a melting point of 220° C. or lower, a thermosetting resin and a flux activator and in which the flux activator has an average particle diameter of 1 μm or more and 15 μm or less.

In addition, Patent Document 3 describes a curing accelerator as a compounded component, and specifically, an imidazole compound is used.

### RELATED ART DOCUMENTS

### Patent Documents

Patent Document 1: JP 2004-260131 A
Patent Document 2: WO 2008/023452 A1
Patent Document 3: WO 2012/102077 A1

### SUMMARY OF THE INVENTION

### Problems to be Solved by the Invention

In conventional solder powders described in Patent Documents 1 and 2 and anisotropic conductive pastes containing conductive particles each having a solder layer at a surface, the moving speed to the electrode (line) of the solder powder or the conductive particles may be slow. In particular, when the conductive material is placed on a substrate or the like and then left for a long time, the solder may hardly aggregate on the electrode in some cases.

When the electrodes are electrically connected by using the conductive adhesive composition described in Patent Document 3, heat resistance of the conductive adhesive is lowered by the imidazole compound as a curing accelerator, and the conductive adhesive may turn yellow during heating.

It is an object of the present invention to provide a conductive material in which, even when the conductive material is left for a certain period of time, solder of conductive particles can be efficiently placed on an electrode, and, in addition, yellowing of the conductive material can be sufficiently suppressed during heating. It is also an object of the present invention to provide a connection structure using the conductive material and a method for producing a connection structure.

### Means for Solving the Problems

According to a broad aspect of the present invention, there is provided a conductive material containing a plurality of conductive particles having solder at an outer surface portion of a conductive portion, a curable compound, and a boron trifluoride complex.

In a specific aspect of the conductive material according to the present invention, the boron trifluoride complex is a boron trifluoride-amine complex.

In a specific aspect of the conductive material according to the present invention, the content of the boron trifluoride complex in 100% by weight of the conductive material is 0.1% by weight or more and 1.5% by weight or less.

In a specific aspect of the conductive material according to the present invention, the conductive material has a viscosity at 25° C. of 50 Pa·s or more and 500 Pa·s or less.

In a specific aspect of the conductive material according to the present invention, the average particle diameter of the conductive particles is 0.5 μm or more and 100 μm or less.

In a specific aspect of the conductive material according to the present invention, the content of the conductive particles in 100% by weight of the conductive material is 30% by weight or more and 95% by weight or less.

In a specific aspect of the conductive material according to the present invention, the conductive material is a conductive paste.

According to a broad aspect of the present invention, there is provided a connection structure including a first connection object member having at least one first electrode on its surface, a second connection object member having at least one second electrode on its surface, and a connection portion connecting the first connection object member and the second connection object member. In this connection structure, the connection portion is formed of the above-described conductive material, and the first electrode and the second electrode are electrically connected by a solder portion in the connection portion.

In a specific aspect of the connection structure according to the present invention, when viewing a portion where the first electrode and the second electrode face each other in a stacking direction of the first electrode, the connection portion, and the second electrode, the solder portion in the connection portion is placed in 50% or more of 100% of the area of the portion where the first electrode and the second electrode face each other.

According to a broad aspect of the present invention, there is provided a method for producing a connection structure, including a process of placing the above-described conductive material on a surface of a first connection object member, having at least one first electrode on its surface, with the use of the conductive material, a process of disposing a second connection object member, having at least one second electrode on its surface, on a surface opposite to the first connection object member side of the conductive material such that the first electrode and the second electrode face each other, and a process of heating the conductive material to a temperature not lower than a melting point of solder of the conductive particles to form a connection portion, connecting the first connection object member and the second connection object member, with the conductive material and electrically connecting the first electrode and the second electrode via a solder portion in the connection portion.

In a specific aspect of the method for producing a connection structure according to the present invention, when viewing a portion where the first electrode and the second electrode face each other in a stacking direction of the first electrode, the connection portion, and the second electrode, the solder portion in the connection portion is placed in 50% or more of 100% of the area of the portion where the first electrode and the second electrode face each other.

### Effect of the Invention

Since the conductive material according to the present invention contains the plurality of conductive particles having solder at the outer surface portion of the conductive portion, the curable compound, and the boron trifluoride complex, even when the conductive material is left for a certain period of time, the solder of conductive particles can be efficiently placed on the electrode, and, in addition, yellowing of the conductive material can be sufficiently suppressed during heating.

### BRIEF DESCRIPTION OF DRAWINGS

FIG. 1 is a cross-sectional view schematically showing a connection structure obtained using a conductive material according to one embodiment of the present invention.

FIGS. 2(a) to 2(c) are cross-sectional views for explaining respective processes of an example of a method for producing a connection structure using the conductive material according to one embodiment of the present invention.

FIG. 3 is a cross-sectional view showing a modified example of the connection structure.

FIG. 4 is a cross-sectional view showing a first example of conductive particles usable for the conductive material.

FIG. 5 is a cross-sectional view showing a second example of the conductive particles usable for the conductive material.

FIG. 6 is a cross-sectional view showing a third example of the conductive particles usable for the conductive material.

### MODE(S) FOR CARRYING OUT THE INVENTION

Hereinafter, the details of the present invention will be described.

(Conductive Material)

A conductive material according to the present invention contains a plurality of conductive particles having solder at an outer surface portion of a conductive portion, a curable compound, and a boron trifluoride complex. The solder is contained in the conductive portion and is a portion or the whole of the conductive portion.

In the present invention, since the above configuration is provided, even when the conductive material is left for a certain period of time, the solder of the conductive particles can be efficiently placed on an electrode, and, in addition, yellowing of the conductive material can be sufficiently suppressed during heating. For example, even when the conductive material is left on the connection object member for a certain period of time after the conductive material is placed on the connection object member such as a substrate, the solder of the conductive particles can be efficiently placed on the electrode.

Further, in the present invention, since the above configuration is provided, when the electrodes are electrically connected, the plurality of conductive particles are likely to gather between the upper and lower opposed electrodes, and the plurality of conductive particles can be efficiently placed on the electrode (line). In addition, such a phenomenon that a portion of the plurality of conductive particles is placed in a region (space) where no electrode is formed is suppressed, and the amount of the conductive particles placed in the region where no electrode is formed can be considerably reduced. Accordingly, the conduction reliability between the electrodes can be enhanced. In addition, it is possible to prevent electrical connection between electrodes that must not be connected and are adjacent in a lateral direction, and insulation reliability can be enhanced.

At the time of producing the connection structure, in particular, at the time of connecting an LED chip to a substrate, it is necessary to dispose the LED chip on the substrate, and therefore, after the conductive material is placed by screen printing or the like, the conductive material may be left for a certain period of time before the LED chip and the substrate are electrically connected. In a conventional conductive material, for example, when the conductive material is left for a certain period of time after the conductive material is placed, conductive particles cannot be efficiently placed on the electrode, so that conduction reliability between the electrodes is reduced. In the present invention, since the above configuration is adopted, even when the conductive material is left for a certain period of time after the conductive material is placed, the conductive particles can be efficiently placed on the electrode, so that the conduction reliability between the electrodes can be sufficiently enhanced.

Further, in the present invention, since the boron trifluoride complex is used as a curing accelerator, yellowing of the conductive material can be sufficiently suppressed during heating. The use of the boron trifluoride complex greatly contributes to obtain such effects.

From the viewpoint of more efficiently placing the solder of the conductive particles on the electrode, the viscosity (η25) of the conductive material at 25° C. is preferably 50 Pa·s or more, more preferably 100 Pa·s or more, and preferably 500 Pa·s or less, more preferably 300 Pa·s or less.

The viscosity (η25) can be appropriately adjusted depending on the type of compounded components and the blending amount. The viscosity can be made relatively high by using a filler.

The viscosity (η25) can be measured under conditions of 25° C. and 5 rpm, for example, using an E-type viscometer (“TVE22L” manufactured by Toki Sangyo Co., Ltd.) or the like.

The conductive material is used as a conductive paste, a conductive film, or the like. The conductive paste is preferably an anisotropic conductive paste, and the conductive film is preferably an anisotropic conductive film. From the viewpoint of further placing the solder of the conductive particles on the electrode, the conductive material is preferably a conductive paste.

The conductive material is suitably used for electrical connection of electrodes. The conductive material is preferably a circuit connecting material.

The conductive material contains a binder. The conductive material contains a curable compound as the binder. The curable compound is preferably a thermosetting compound. The conductive material and the binder may contain a thermosetting agent. The conductive material and the binder preferably contain no thermosetting agent. It is preferable that the binder and the curable compound are liquid components at 25° C. or components which become liquid at the time of conductive connection.

Hereinafter, each component contained in the conductive material will be described.

(Conductive Particles)

The conductive particles electrically connect electrodes of connection object members. The conductive particles have solder at an outer surface portion of a conductive portion. The conductive particles may be solder particles formed by solder. The solder particles have solder at the outer surface portion of the conductive portion. In the solder particle, both the center portion and the outer surface portion of the conductive portion are formed of solder. The solder particle is a particle whose both center portion and conductive outer surface are solder. The conductive particles may have base particles and a conductive portion disposed on the surface of the base particle. In this case, the conductive particles have solder at the outer surface portion of the conductive portion.

The conductive particles have solder at an outer surface portion of a conductive portion. The base particles may be solder particles formed by solder. The conductive particle may be a solder particle in which both the base particle and the outer surface portion of the conductive portion are solder.

When conductive particles including base particles, which are not formed from solder, and a solder portion placed on the surface of the base particles are used, compared to the case of using the solder particles, the conductive particles hardly gather on the electrode. When the conductive particles including the base particles, which are not formed from solder, and the solder portion placed on the surface of the base particles are used, the solder-bonding property between the conductive particles is low; therefore, the conductive particles moved on the electrode tend to move outside the electrode, and the effect of suppressing positional displacement between the electrodes tends to be low. Accordingly, the conductive particles are preferably the solder particles formed by solder.

From the viewpoint of further lowering connection resistance in the connection structure and further suppressing generation of voids, it is preferable that an outer surface of the conductive particles (outer surface of solder) has a carboxyl group or an amino group, preferably the carboxyl group, and preferably the amino group. It is preferable that a group containing a carboxyl group or an amino group is covalently bonded to the outer surface of the conductive particles (outer surface of solder) via a Si—O bond, an ether bond, an ester bond or a group represented by the following formula (X). The group containing a carboxyl group or an amino group may contain both the carboxyl group and the amino group. In the following formula (X), the right end and the left end represent binding sites.

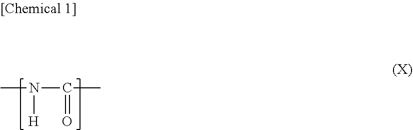

A hydroxyl group is present on the surface of the solder. When the hydroxyl group and a carboxyl group-containing group are covalently bonded, a stronger bond can be formed as compared with the case where the hydroxyl group and the group containing a carboxyl group are bonded by another coordinate bond (chelate coordination) or the like, so that it is possible to obtain conductive particles capable of lowering the connection resistance between the electrodes and suppressing generation of voids.

In the conductive particles, the bond form between the surface of the solder and the carboxyl group-containing group may not include a coordination bond and a bond according to chelate coordination.

From the viewpoint of further lowering the connection resistance in the connection structure and further suppressing generation of voids, it is preferable that the conductive particles are obtained by reacting a functional group capable of reacting with a hydroxyl group with the hydroxyl group on the surface of the solder, using a compound (hereinafter sometimes to be referred to as compound X) having a carboxyl group or an amino group and the functional group capable of reacting with a hydroxyl group. In the above reaction, a covalent bond is formed. The conductive particles in which the group containing a carboxyl group or an amino group is covalently bonded to the surface of the solder can be easily obtained by reacting a hydroxyl group on the surface of the solder with the functional group capable of reacting with a hydroxyl group in the compound X. In addition, the conductive particles in which the group containing a carboxyl group or an amino group is covalently bonded to the surface of the solder via an ether bond or an ester bond can be obtained by reacting a hydroxyl group on the surface of the solder with the functional group capable of reacting with a hydroxyl group in the compound X. The compound X can be chemically bonded in the form of a covalent bond to the surface of the solder by reacting the functional group capable of reacting with a hydroxyl group with the hydroxyl group on the surface of the solder.

Examples of the functional group capable of reacting with a hydroxyl group include a hydroxyl group, a carboxyl group, an ester group and a carbonyl group. The functional group capable of reacting with a hydroxyl group is preferably a hydroxyl group or a carboxyl group. The functional group capable of reacting with a hydroxyl group may be a hydroxyl group or a carboxyl group.

Examples of a compound having a functional group capable of reacting with a hydroxyl group include levulinic acid, glutaric acid, glycolic acid, succinic acid, malic acid, oxalic acid, malonic acid, adipic acid, 5-ketohexanoic acid, 3-hydroxypropionic acid, 4-aminobutyric acid, 3-mercaptopropionic acid, 3-mercaptoisobutyric acid, 3-methylthiopropionic acid, 3-phenylpropionic acid, 3-phenylisobutyric acid, 4-phenylbutyric acid, decanoic acid, dodecanoic acid, tetradecanoic acid, pentadecanoic acid, hexadecanoic acid, 9-hexadecenoic acid, heptadecanoic acid, stearic acid, oleic acid, vaccenic acid, linoleic acid, (9,12,15)-linolenic acid, nonadecanoic acid, arachidic acid, decanedioic acid and dodecanedioic acid. Glutaric acid or glycolic acid is preferred. One kind of the compound having the functional group capable of reacting with a hydroxyl group may be used alone, and two or more kinds thereof may be used in combination. The compound having the functional group capable of reacting with a hydroxyl group is preferably a compound having at least one carboxyl group.

The compound X preferably has a flux action, and it is preferable that the compound X has the flux action in a state of being bonded to the surface of the solder. The compound having the flux action can remove an oxide film on the surface of the solder and an oxide film on the surface of the electrode. A carboxyl group has the flux action.

Examples of the compound having the flux action include levulinic acid, glutaric acid, glycolic acid, adipic acid, succinic acid, 5-ketohexanoic acid, 3-hydroxypropionic acid, 4-aminobutyric acid, 3-mercaptopropionic acid, 3-mercaptoisobutyric acid, 3-methylthiopropionic acid, 3-phenylpropionic acid, 3-phenylisobutyric acid and 4-phenylbutyric acid. Glutaric acid, adipic acid or glycolic acid is preferred. One kind of the compound having the flux action may be used alone, and two or more kinds thereof may be used in combination.

From the viewpoint of further lowering the connection resistance in the connection structure and further suppressing generation of voids, it is preferable that the functional group capable of reacting with a hydroxyl group in the compound X is a hydroxyl group or a carboxyl group. The functional group capable of reacting with a hydroxyl group in the compound X may be a hydroxyl group or a carboxyl group. When the functional group capable of reacting with a hydroxyl group is a carboxyl group, it is preferable that the compound X has at least two carboxyl groups. The conductive particles in which the carboxyl group-containing group is covalently bonded to the surface of the solder can be obtained by reacting a carboxyl group of a portion of a compound having at least two carboxyl groups with a hydroxyl group on the surface of the solder.

A method of producing the conductive particles includes, for example, a process of mixing conductive particles, a compound having a carboxyl group and a functional group capable of reacting with a hydroxyl group, a catalyst, and a solvent with the use of the conductive particles. In the method of producing conductive particles, conductive particles in which the carboxyl group-containing group is covalently bonded to the surface of the solder can be easily obtained by the mixing process.

Further, in the method of producing conductive particles, it is preferable that conductive particles, the compound having a carboxyl group and the functional group capable of reacting with a hydroxyl group, the catalyst, and the solvent are mixed using the conductive particles and heated. The conductive particles in which the carboxyl group-containing group is covalently bonded to the surface of the solder can be more easily obtained by the mixing and heating process.

Examples of the solvent include alcohol solvents such as methanol, ethanol, propanol and butanol, acetone, methyl ethyl ketone, ethyl acetate, toluene and xylene. The solvent is preferably an organic solvent, more preferably toluene. One kind of the solvent may be used alone, and two or more kinds thereof may be used in combination.

Examples of the catalyst include p-toluenesulfonic acid, benzenesulfonic acid and 10-camphorsulfonic acid. The catalyst is preferably p-toluenesulfonic acid. One kind of the catalyst may be used alone, and two or more kinds thereof may be used in combination.

It is preferable to heat at the time of the mixing. The heating temperature is preferably 90° C. or higher, more preferably 100° C. or higher, and preferably 130° C. or lower, more preferably 110° C. or lower.

From the viewpoint of further lowering the connection resistance in the connection structure and further suppressing generation of voids, it is preferable that the conductive particles are obtained using an isocyanate compound through a process of reacting the isocyanate compound with a hydroxyl group on the surface of the solder. In the above reaction, a covalent bond is formed. The conductive particles in which a nitrogen atom of a group derived from the isocyanate group is covalently bonded to the surface of the solder can be easily obtained by reacting a hydroxyl group on the surface of the solder and the isocyanate compound. By reacting the hydroxyl group on the surface of the solder with the isocyanate compound, the group derived from the isocyanate group can be chemically bonded to the surface of the solder in the form of covalent bond.

With the group derived from the isocyanate group, a silane coupling agent can be easily reacted. Since the conductive particles can be easily obtained, it is preferable that the carboxyl group-containing group is introduced by a reaction using a silane coupling agent having a carboxyl group. In addition, since the conductive particles can be easily obtained, it is preferable that after a reaction using a silane coupling agent, the carboxyl group-containing group is introduced by reacting a compound having at least one carboxyl group with a group derived from the silane coupling agent. It is preferable that the conductive particles are obtained by reacting the isocyanate compound with the hydroxyl group on the surface of the solder with the use of the isocyanate compound and then reacting the compound having at least one carboxyl group.

From the viewpoint of effectively lowering connection resistance in the connection structure and effectively suppressing generation of voids, it is preferable that the compound having at least one carboxyl group has a plurality of carboxyl groups.

Examples of the isocyanate compound include diphenylmethane-4,4′-diisocyanate (MDI), hexamethylene diisocyanate (HDI), toluene diisocyanate (TDI) and isophorone diisocyanate (IPDI). Other isocyanate compounds may be used. After this compound is reacted with the surface of the solder, the remaining isocyanate group and a compound having reactivity with the remaining isocyanate group and having a carboxyl group are reacted, whereby the carboxyl group can be introduced onto the surface of the solder via the group represented by the above formula (X).

As the isocyanate compound, a compound having an unsaturated double bond and having an isocyanate group may be used. Examples thereof include 2-acryloyloxyethyl isocyanate and 2-isocyanatoethyl methacrylate. After the isocyanate group of the compound is reacted with the surface of the solder, a compound which has a functional group having reactivity with the remaining unsaturated double bond and has a carboxyl group is reacted, so that the carboxyl group can be introduced onto the surface of the solder via the group represented by the above formula (X).

Examples of the silane coupling agent include 3-isocyanatepropyltriethoxysilane (“KBE-9007” manufactured by Shin-Etsu Chemical Co., Ltd.) and 3-isocyanatepropyltrimethoxysilane (“Y-5187” manufactured by Momentive Performance Materials Inc). One kind of the silane coupling agent may be used alone, and two or more kinds thereof may be used in combination.

Examples of the compound having at least one carboxyl group include levulinic acid, glutaric acid, glycolic acid, succinic acid, malic acid, oxalic acid, malonic acid, adipic acid, 5-ketohexanoic acid, 3-hydroxypropionic acid, 4-aminobutyric acid, 3-mercaptopropionic acid, 3-mercaptoisobutyric acid, 3-methylthiopropionic acid, 3-phenylpropionic acid, 3-phenylisobutyric acid, 4-phenylbutyric acid, decanoic acid, dodecanoic acid, tetradecanoic acid, pentadecanoic acid, hexadecanoic acid, 9-hexadecenoic acid, heptadecanoic acid, stearic acid, oleic acid, vaccenic acid, linoleic acid, (9,12,15)-linolenic acid, nonadecanoic acid, arachidic acid, decanedioic acid and dodecanedioic acid. Glutaric acid, adipic acid or glycolic acid is preferred. One kind of the compound having at least one carboxyl group may be used alone, and two or more kinds thereof may be used in combination.

After the isocyanate compound is reacted with the hydroxyl group on the surface of the solder with the use of the isocyanate compound, a carboxyl group of a portion of a compound having a plurality of carboxyl groups is reacted with the hydroxyl group on the surface of the solder, so that the carboxyl group-containing group can be allowed to remain.

In the method of producing conductive particles, conductive particles and an isocyanate compound are used, and after the isocyanate compound is reacted with a hydroxyl group on the surface of solder, the compound having at least one carboxyl group is reacted to obtain conductive particles in which the carboxyl group-containing group is bonded to the surface of the solder via the group represented by the above formula (X). In the method of producing conductive particles, conductive particles in which the carboxyl group-containing group is introduced onto the surface of the solder can be easily obtained by the above process.

Specific methods of producing conductive particles include the following methods. Conductive particles are dispersed in an organic solvent, and an isocyanate group-containing silane coupling agent is added. Thereafter, a silane coupling agent is covalently bonded to the surface of the solder by using a reaction catalyst of the hydroxyl group on the surface of the solder of the conductive particles and the isocyanate group. Then, a hydroxyl group is generated by hydrolyzing an alkoxy group bonded to a silicon atom of the silane coupling agent. A carboxyl group of the compound having at least one carboxyl group is reacted with the generated hydroxyl group.

Specific methods of producing conductive particles include the following methods. Conductive particles are dispersed in an organic solvent, and a compound having an isocyanate group and an unsaturated double bond is added. Thereafter, a covalent bond is formed using a reaction catalyst of the hydroxyl group on the surface of the solder of the conductive particles and the isocyanate group. Thereafter, a compound having an unsaturated double bond and a carboxyl group is reacted with the introduced unsaturated double bond.

Examples of the reaction catalyst of the hydroxyl group on the surface of the solder of the conductive particles and the isocyanate group include a tin catalyst (such as dibutyltin dilaurate), an amine catalyst (such as triethylenediamine), a carboxylate catalyst (such as lead naphthenate and potassium acetate), and a trialkylphosphine catalyst (such as triethylphosphine).

From the viewpoint of effectively lowering the connection resistance in the connection structure and effectively suppressing generation of voids, the compound having at least one carboxyl group is preferably a compound represented by the following formula (1). The compound represented by the following formula (1) has the flux action. The compound represented by the following formula (1) has the flux action in a state of being introduced onto the surface of the solder.

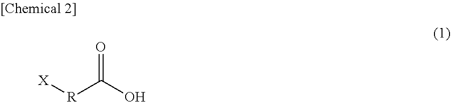

In the above formula (1), X represents a functional group capable of reacting with a hydroxyl group, and R represents a divalent organic group having 1 to 5 carbon atoms. The organic group may contain a carbon atom, a hydrogen atom, and an oxygen atom. The organic group may be a divalent hydrocarbon group having 1 to 5 carbon atoms. The main chain of the organic group is preferably a divalent hydrocarbon group. In the organic group, a carboxyl group or a hydroxyl group may be bonded to the divalent hydrocarbon group. The compound represented by the above formula (1) include, for example, citric acid.

The compound having at least one carboxyl group is preferably a compound represented by the following formula (1A) or (1B). The compound having at least one carboxyl group is preferably the compound represented by the following formula (1A), more preferably the compound represented by the following formula (1B).

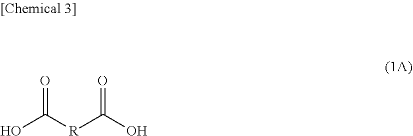

In the above formula (1A), R represents a divalent organic group having 1 to 5 carbon atoms. R in the above formula (1A) is the same as R in the above formula (1).

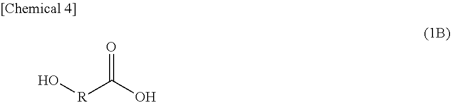

In the above formula (1B), R represents a divalent organic group having 1 to 5 carbon atoms. R in the above formula (1B) is the same as R in the above formula (1).

It is preferable that a group represented by the following formula (2A) or the following formula (2B) is bonded to the surface of the solder. It is preferable that the group represented by the following formula (2A) is bonded to the surface of the solder, and it is more preferable that the group represented by the following formula (2B) is bonded to the surface of the solder. In the following formulas (2A) and (2B), the left end represents a binding site.

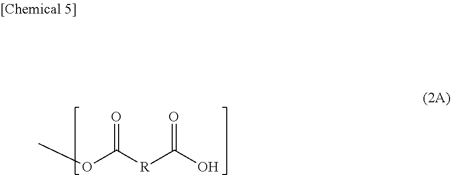

In the above formula (2A), R represents a divalent organic group having 1 to 5 carbon atoms. R in the above formula (2A) is the same as R in the above formula (1).

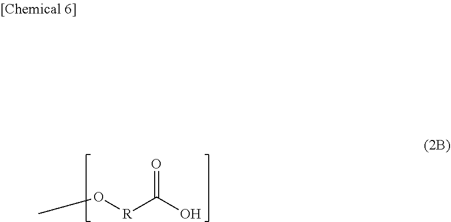

In the above formula (2B), R represents a divalent organic group having 1 to 5 carbon atoms. R in the above formula (2B) is the same as R in the above formula (1).

From the viewpoint of further enhancing wettability of the surface of the solder, the molecular weight of the compound having at least one carboxyl group is preferably 10000 or less, more preferably 1000 or less, further preferably 500 or less.

When the compound having at least one carboxyl group is not a polymer and when a structural formula of the compound having at least one carboxyl group can be specified, the molecular weight means a molecular weight that can be calculated from the structural formula. When the compound having at least one carboxyl group is a polymer, this molecular weight means a weight average molecular weight.

From the viewpoint of more efficiently placing the solder of the conductive particles between the electrodes, the conductive particle preferably has a conductive particle and an anionic polymer disposed on the surface of the conductive particle. It is preferable that the conductive particles are obtained by surface-treating the conductive particles with an anionic polymer or a compound to be an anionic polymer. The conductive particle is preferably a surface-treated product obtained using an anionic polymer or a compound to be an anionic polymer. One kind of the anionic polymer or the compound to be an anionic polymer may be used alone, and two or more kinds thereof may be used in combination.

Examples of the method of surface-treating a conductive particle body with an anionic polymer include a method of reacting a carboxyl group of the anionic polymer with a hydroxyl group on the surface of the conductive particle body. Examples of the anionic polymer used for this reaction include a (meth)acrylic polymer obtained by copolymerizing (meth)acrylic acid, a polyester polymer synthesized from dicarboxylic acid and diol and having carboxyl groups at both ends, a polymer obtained by an intermolecular dehydration condensation reaction of dicarboxylic acid and having carboxyl groups at both ends, a polyester polymer synthesized from dicarboxylic acid and diamine and having carboxyl groups at both ends, and modified poval (“GOHSENX T” manufactured by The Nippon Synthetic Chemical Industry Co., Ltd.) having a carboxyl group.

Examples of the anion moiety of the anionic polymer include the carboxyl group, and besides a tosyl group (p-H₃CC₆H₄S(═O)₂—), a sulfonic acid ion group (—SO₃⁻), and a phosphate ion group (—PO₄—).

Examples of other surface treatment methods include a method in which a compound, which has a functional group reacting with a hydroxyl group on the surface of the conductive particle body and has a functional group polymerizable by an addition and condensation reaction, is used, and this compound is polymerized on the surface of the conductive particle body. Examples of the functional group reacting with the hydroxyl group on the surface of the conductive particle body include a carboxyl group and an isocyanate group, and examples of the functional group polymerized by the addition and condensation reaction include a hydroxyl group, a carboxyl group, an amino group, and a (meth)acryloyl group.

The weight average molecular weight of the anionic polymer is preferably 2000 or more, more preferably 3000 or more, and preferably 10000 or less, more preferably 8000 or less. When the weight average molecular weight is not less than the above lower limit and not more than the above upper limit, a sufficient amount of electric charge and flux properties can be introduced to the surface of the conductive particles. This makes it possible to effectively increase aggregation of the conductive particles at the time of conductive connection and effectively remove an oxide film on the surface of the electrode when a connection object member is connected.

When the weight average molecular weight is not less than the above lower limit and not more than the above upper limit, it is easy to dispose an anionic polymer on the surface of the conductive particle body, aggregation of solder particles can be effectively increased at the time of conductive connection, and the conductive particles can be more efficiently placed on the electrode.

The weight average molecular weight means a weight average molecular weight in terms of polystyrene measured by gel permeation chromatography (GPC).

The weight average molecular weight of a polymer obtained by surface-treating the conductive particle body with the compound to be an anionic polymer can be determined by dissolving the solder of the conductive particles, removing the conductive particles with diluted hydrochloric acid or the like which does not cause decomposition of the polymer, and then measuring the weight average molecular weight of the remaining polymer.

With respect to the amount of anionic polymer introduced to the surface of the conductive particles, the acid value per 1 g of the conductive particles is preferably 1 mg KOH or more, more preferably 2 mg KOH or more, and preferably 10 mg KOH or less, more preferably 6 mg KOH or less.

The acid value can be measured as follows.

1 g of conductive particles is added to 36 g of acetone and dispersed by ultrasonic wave for 1 minute. Thereafter, phenolphthalein is used as an indicator, and titration is performed with a 0.1 mol/L potassium hydroxide ethanol solution.

Next, specific examples of the conductive particles will be described with reference to the drawings.

FIG. 4 is a cross-sectional view showing a first example of conductive particles usable for the conductive material.

Conductive particles 21 shown in FIG. 4 are solder particles. The entire conductive particle 21 is formed of solder. The conductive particle 21 does not have a base particle in the core and is not a core shell particle. In the conductive particle 21, both the center portion and an outer surface portion of a conductive portion are formed of solder.

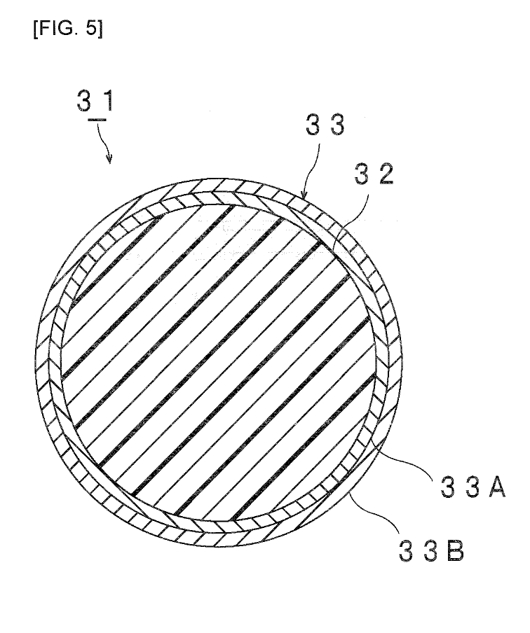

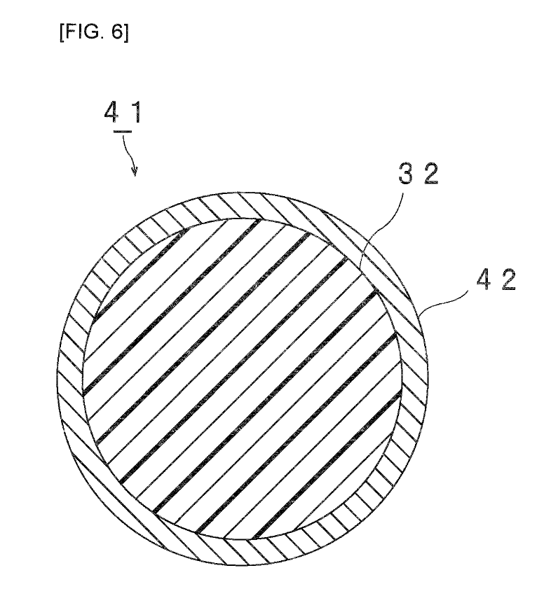

FIG. 5 is a cross-sectional view showing a second example of the conductive particles usable for the conductive material.

A conductive particle 31 shown in FIG. 5 includes a base particle 32 and a conductive portion 33 disposed on the surface of the base particle 32. The conductive portion 33 covers the surface of the base particle 32. The conductive particle 31 is a covered particle in which the surface of the base particle 32 is covered with the conductive portion 33.

The conductive portion 33 has a second conductive portion 33A and a solder portion 33B (first conductive portion). The conductive particle 31 includes the second conductive portion 33A between the base particle 32 and the solder portion 33B. Accordingly, the conductive particle 31 includes the base particle 32, the second conductive portion 33A disposed on the surface of the base particle 32, and the solder portion 33B disposed at an outer surface of the second conductive portion 33A.

FIG. 6 is a cross-sectional view showing a third example of the conductive particles usable for the conductive material.

The conductive portion 33 of the conductive particle 31 has a two-layer structure. A conductive particle 41 shown in FIG. 6 has a solder portion 42 as a single layer conductive portion. The conductive particle 41 includes the base particle 32 and the solder portion 42 disposed on the surface of the base particle 32.

Hereinafter, other details of the conductive particles will be described.

(Base Particle)

Examples of the base particle include resin particles, inorganic particles excluding metal particles, organic-inorganic hybrid particles, and metal particles. The base particle is preferably a base particle excluding a metal, and is preferably a resin particle, an inorganic particle excluding a metal particle, or an organic-inorganic hybrid particle. The base particle may be a copper particle. The base particle may have a core and a shell disposed on the surface of the core, and may be a core-shell particle. The core may be an organic core, and the shell may be an inorganic shell.

Various organic substances are suitably used as a resin for forming the resin particle. Examples of the resin for forming the resin particle include polyolefin resins such as polyethylene, polypropylene, polystyrene, polyvinyl chloride, polyvinylidene chloride, polyisobutylene, and polybutadiene; acrylic resins such as polymethyl methacrylate and polymethyl acrylate; polycarbonate, polyamide, phenol formaldehyde resin, melamine formaldehyde resin, benzoguanamine formaldehyde resin, urea formaldehyde resin, phenol resin, melamine resin, benzoguanamine resin, urea resin, epoxy resin, unsaturated polyester resin, saturated polyester resin, polyethylene terephthalate, polysulfone, polyphenylene oxide, polyacetal, polyimide, polyamideimide, polyether ether ketone, polyether sulfone, divinylbenzene polymer, and divinylbenzene-based copolymer. Examples of the divinylbenzene-based copolymer include divinylbenzene-styrene copolymer and divinylbenzene-(meth)acrylate copolymer. Since the hardness of the resin particle can be easily controlled within a preferable range, the resin for forming the resin particle is preferably a polymer obtained by polymerizing one or more polymerizable monomers having an ethylenically unsaturated group.

When the resin particle is obtained by polymerizing a polymerizable monomer having an ethylenically unsaturated group, examples of the polymerizable monomer having an ethylenically unsaturated group include non-crosslinkable monomers and crosslinkable monomers.

Examples of the non-crosslinkable monomers include styrene-based monomers such as styrene and α-methylstyrene; carboxyl group-containing monomers such as (meth)acrylic acid, maleic acid and maleic anhydride; alkyl (meth)acrylate compounds such as methyl (meth)acrylate, ethyl (meth)acrylate, propyl (meth)acrylate, butyl (meth)acrylate, 2-ethyl hexyl (meth)acrylate, lauryl (meth)acrylate, cetyl (meth)acrylate, stearyl (meth)acrylate, and isobornyl (meth)acrylate; oxygen atom-containing (meth)acrylate compounds such as 2-hydroxyethyl (meth)acrylate, glycerol (meth)acrylate, polyoxyethylene (meth)acrylate, and glycidyl (meth)acrylate; nitrile-containing monomers such as (meth)acrylonitrile; vinyl ether compounds such as methyl vinyl ether, ethyl vinyl ether, and propyl vinyl ether; acid vinyl ester compounds such as vinyl acetate, vinyl butyrate, vinyl laurate, and vinyl stearate; unsaturated hydrocarbons such as ethylene, propylene, isoprene, and butadiene; and halogen-containing monomers such as trifluoromethyl (meth)acrylate, pentafluoroethyl (meth)acrylate, vinyl chloride, vinyl fluoride, and chlorostyrene.

Examples of the crosslinkable monomers include polyfunctional (meth)acrylate compounds such as tetramethylolmethane tetra(meth)acrylate, tetramethylolmethane tri(meth)acrylate, tetramethylolmethane di(meth)acrylate, trimethylolpropane tri(meth)acrylate, dipentaerythritol hexa(meth)acrylate, dipentaerythritol penta(meth)acrylate, glycerol tri(meth)acrylate, glycerol di(meth)acrylate, (poly)ethylene glycol di(meth)acrylate, (poly)propylene glycol di(meth)acrylate, (poly)tetramethylene glycol di(meth)acrylate, and 1,4-butanediol di(meth)acrylate; and silane-containing monomers such as triallyl (iso)cyanurate, triallyl trimellitate, divinylbenzene, diallyl phthalate, diallyl acrylamide, diallyl ether, γ-(meth)acryloxy propyl trimethoxy silane, trimethoxy silyl styrene, and vinyltrimethoxysilane.

The term “(meth)acrylate” refers to an acrylate and a methacrylate. The term “(meth)acrylic” refers to an acrylic and a methacrylic. The term “(meth)acryloyl” refers to an acryloyl and a methacryloyl.

The resin particle can be obtained by polymerizing the polymerizable monomer having an ethylenically unsaturated group by a known method. Examples of this method include a method of suspension polymerization in the presence of a radical polymerization initiator, and a method of swelling non-crosslinked seed particles with monomers and a radical polymerization initiator and polymerizing the monomers.

When the base particle is an inorganic particle excluding a metal or an organic-inorganic hybrid particle, examples of the inorganic substance for forming the base particle include silica, alumina, barium titanate, zirconia, and carbon black. It is preferable that the inorganic substance is not a metal. The particles formed of the silica are not particularly limited, and examples thereof include particles obtained by hydrolyzing a silicon compound having two or more hydrolyzable alkoxysilyl groups to form crosslinked polymer particles and then performing firing as necessary. Examples of the organic-inorganic hybrid particles include organic-inorganic hybrid particles formed of crosslinked alkoxysilyl polymer and an acrylic resin.

The organic-inorganic hybrid particle is preferably a core-shell type organic-inorganic hybrid particle having a core and a shell disposed on the surface of the core. The core is preferably an organic core. The shell is preferably an inorganic shell. From the viewpoint of further lowering connection resistance between the electrodes, the base particle is preferably an organic-inorganic hybrid particle having an organic core and an inorganic shell disposed on the surface of the organic core.

Examples of the material for forming the organic core include the above-described resins for forming the resin particle.

Examples of the material for forming the inorganic shell include the above-described inorganic substances for forming the base particle. The material for forming the inorganic shell is preferably silica. It is preferable that the inorganic shell is formed by forming metal alkoxide into a shell-like material on the surface of the core by a sol-gel method and then firing the shell-like material. The metal alkoxide is preferably a silane alkoxide. It is preferable that the inorganic shell is formed of a silane alkoxide.

The particle diameter of the core is preferably 0.5 μm or more, more preferably 1 μm or more, and preferably 100 μm or less, more preferably 50 μm or less. When the particle diameter of the core is not less than the above lower limit and not more than the above upper limit, conductive particles more preferable for electrical connection between the electrodes are obtained, and the base particle can be suitably used for conductive particles. For example, if the particle diameter of the core is not less than the above lower limit and not more than the above upper limit, when the electrodes are connected using the conductive particles, the contact area between the conductive particles and the electrodes becomes sufficiently large, and when the conductive portion is formed on the surface of the base particle, aggregated conductive particles can be hardly formed. In addition, an interval between the electrodes connected via the conductive particles does not become too large, and the conductive portion can hardly peel off from the surface of the base particle.

The particle diameter of the core means the diameter when the core has a spherical shape and means the maximum diameter when the core has a shape other than a spherical shape. The particle diameter of the core means the average particle diameter of the core measured by any particle diameter measuring device. For example, a particle size distribution measuring apparatus using principles such as laser light scattering, electric resistance change, and image analysis after imaging can be used.

The thickness of the shell is preferably 100 nm or more, more preferably 200 nm or more, and preferably 5 μm or less, more preferably 3 μm or less. When the thickness of the shell is not less than the above lower limit and not more than the above upper limit, conductive particles more preferable for electrical connection between the electrodes are obtained, and the base particle can be suitably used for conductive particles. The thickness of the shell is an average thickness per base particle. The thickness of the shell can be controlled by controlling the sol-gel method.

When the base particle is a metal particle, examples of a metal for forming the metal particle include silver, copper, nickel, silicon, gold and titanium. When the base particle is a metal particle, the metal particle is preferably a copper particle. However, it is preferable that the base particle is not a metal particle.

The particle diameter of the base particle is preferably 0.5 μm or more, more preferably 1 μm or more, and preferably 100 μm or less, more preferably 50 μm or less. When the particle diameter of the base particle is not less than the above lower limit, the contact area between the conductive particles and the electrodes becomes large, so that it is possible to further enhance the conduction reliability between the electrodes and to further lower the connection resistance between the electrodes connected via the conductive particles. When the particle diameter of the base particle is not more than the above upper limit, the conductive particles are easily compressed sufficiently, and it is possible to further lower the connection resistance between the electrodes and, in addition, to further reduce the interval between the electrodes.

The particle diameter of the base particle indicates the diameter when the base particle has a spherical shape, and indicates the maximum diameter when the base particle does not have a spherical shape.

The base particle has a particle diameter of particularly preferably 5 μm or more and 40 μm or less. When the particle diameter of the base particle is in the range of 5 μm or more and 40 μm or less, the interval between the electrodes can be further reduced, and even when the thickness of a conductive layer is increased, small conductive particles can be obtained.

(Conductive Portion)

A method of forming a conductive portion on the surface of the base particle and a method of forming a solder portion on the surface of the base particle or on the surface of the second conductive portion are not particularly limited. Examples of the method of forming the conductive portion or the solder portion include a method by electroless plating, a method by electroplating, a method by physical collision, a method by mechanochemical reaction, a method by physical vapor deposition or physical adsorption, and a method of coating paste containing a metal powder or paste containing a metal powder and a binder on the surface of the base particle. The method by electroless plating, electroplating, or physical collision is particularly preferable. Examples of the method by physical vapor deposition include methods of vacuum deposition, ion plating, ion sputtering and the like. In the method by physical collision, for example, Theta Composer (manufacture by TOKUJU Co., LTD) or the like is used.

The melting point of the base particle is preferably higher than the melting points of the conductive portion and the solder portion. The melting point of the base particle is preferably higher than 160° C., more preferably higher than 300° C., further preferably higher than 400° C., particularly preferably higher than 450° C. The melting point of the base particle may be lower than 400° C. The melting point of the base particle may be 160° C. or lower. The softening point of the base particle is preferably 260° C. or higher. The softening point of the base particle may be lower than 260° C.

The conductive particle may have a single layer solder portion. The conductive particle may have conductive portions (solder portion, second conductive portion) constituted of a plurality of layers. That is, in the conductive particle, two or more conductive portions may be stacked. When two or more conductive portions are stacked, the conductive particle preferably has solder at the outer surface portion of the conductive portion.

The solder is preferably a metal (low melting point metal) having a melting point of 450° C. or lower. The solder portion is preferably a metal layer (low melting point metal layer) having a melting point of 450° C. or lower. The low melting point metal layer is a layer containing a low melting point metal. The solder of the conductive particles preferably correspond to metal particles (low melting point metal particles) having a melting point of 450° C. or lower. The low melting point metal particle is a particle containing a low melting point metal. The low melting point metal indicates a metal having a melting point of 450° C. or lower. The melting point of the low melting point metal is preferably 300° C. or lower, more preferably 160° C. or lower. The solder of the conductive particles preferably contains tin. The content of tin in 100% by weight of metal contained in the solder portion and in 100% by weight of metal contained in the solder of the conductive particles is preferably 30% by weight or more, more preferably 40% by weight or more, further preferably 70% by weight or more, particularly preferably 90% by weight or more. When the content of tin contained in the solder of the conductive particles is not less than the above lower limit, the conduction reliability between the conductive particles and the electrode is further enhanced.

The content of tin can be measured by using a high-frequency inductively coupled plasma emission spectrometry apparatus (“ICP-AES” manufactured by Horiba, Ltd.), a fluorescence X-ray analyzing apparatus (“EDX-800HS” manufactured by Shimadzu Corporation), or the like.

By using the conductive particles having the solder at the outer surface portion of the conductive portion, the solder melts to be bonded to the electrode, and the solder conducts between the electrodes. For example, since the solder and the electrode are easily in surface contact, not in point contact, the connection resistance decreases. Further, the use of the conductive particles having the solder at the outer surface portion of the conductive portion increases bonding strength between the solder and the electrode, so that peeling between the solder and the electrode more hardly occurs, and conduction reliability effectively increases.

The low melting point metal constituting the solder portion and the solder is not particularly limited. The low melting point metal is preferably tin or an alloy containing tin. Examples of the alloy include tin-silver alloy, tin-copper alloy, tin-silver-copper alloy, tin-bismuth alloy, tin-zinc alloy, and tin-indium alloy. Among these, the low melting point metal is preferably tin, tin-silver alloy, tin-silver-copper alloy, tin-bismuth alloy, or tin-indium alloy because of being excellent in wettability to the electrodes. The low melting point metal is more preferably tin-bismuth alloy or tin-indium alloy.

The material for forming the solder (solder portion) is preferably a filler material having a liquidus line of 450° C. or lower in accordance with JIS Z3001: Welding Terms. Examples of the composition of the solder include metallic compositions including zinc, gold, silver, lead, copper, tin, bismuth and indium. Particularly, a low-melting and lead-free tin-indium-based (eutectic 117° C.) or tin-bismuth-based (eutectic 139° C.) solder is preferable. That is, preferably the solder does not contain lead, and is preferably a solder containing tin and indium or a solder containing tin and bismuth.

In order to further increase the bonding strength between the solder and the electrode, the solder of the conductive particles may contain a metal such as nickel, copper, antimony, aluminum, zinc, iron, gold, titanium, phosphorus, germanium, tellurium, cobalt, bismuth, manganese, chromium, molybdenum, or palladium. From the viewpoint of still further increasing the bonding strength between the solder and the electrode, the solder of the conductive particles preferably contains nickel, copper, antimony, aluminum, or zinc. From the viewpoint of further increasing the bonding strength between the solder portion or the solder of the conductive particles and the electrode, the content of these metals for increasing the bonding strength is preferably 0.0001% by weight or more and preferably 1% by weight or less in 100% by weight of the solder of the conductive particles.

The melting point of the second conductive portion is preferably higher than the melting point of the solder portion. The melting point of the second conductive portion is preferably higher than 160° C., more preferably higher than 300° C., further preferably higher than 400° C., even more preferably higher than 450° C., particularly preferably higher than 500° C., most preferably higher than 600° C. Since the solder portion has a low melting point, the solder portion melts at the time of conductive connection. It is preferable that the second conductive portion does not melt at the time of conductive connection. It is preferable that the conductive particles are used by melting the solder, it is preferable that the conductive particles are used by melting the solder portion, and it is preferable that the conductive particles are used by melting the solder portion without melting the second conductive portion. Since the melting point of the second conductive portion is higher than the melting point of the solder portion, only the solder portion can be melted without melting the second conductive portion at the time of conductive connection.

An absolute value of a difference between the melting point of the solder portion and the melting point of the second conductive portion is higher than 0° C., preferably 5° C. or higher, more preferably 10° C. or higher, further preferably 30° C. or higher, particularly preferably 50° C. or higher, most preferably 100° C. or higher.

The second conductive portion preferably contains metal. The metal constituting the second conductive portion is not particularly limited. Examples of the metal include gold, silver, copper, platinum, palladium, zinc, lead, aluminum, cobalt, indium, nickel, chromium, titanium, antimony, bismuth, germanium, cadmium, and alloys of these. As the metal, tin-doped indium oxide (ITO) may be used. One kind of the metal may be used alone, and two or more kinds thereof may be used in combination.

The second conductive portion is preferably a nickel, palladium, copper, or gold layer, more preferably a nickel or gold layer, and still more preferably a copper layer. The conductive particle preferably has a nickel, palladium, copper or gold layer, more preferably a nickel or gold layer, and still more preferably a copper layer. Use of the conductive particles each having such a preferable conductive portion for connecting the electrodes further lowers the connection resistance between the electrodes. Additionally, on the surface of such a preferable conductive portion, a solder portion can be more easily formed.

The thickness of the solder portion is preferably 0.005 μm or more, more preferably 0.01 μm or more, and preferably 10 m or less, more preferably 1 μm or less, further preferably 0.3 μm or less. When the thickness of the solder portion is not less than the above lower limit and not more than the above upper limit, sufficient conductivity is obtained, and the conductive particles do not become too hard, and the conductive particles are sufficiently deformed when the electrodes are connected to each other.

The average particle diameter of the conductive particles is preferably 0.5 μm or more, more preferably 1 μm or more, and preferably 100 μm or less, more preferably 50 μm or less, further preferably 30 μm or less. When the average particle diameter of the conductive particles is not less than the above lower limit and not more than the above upper limit, the conductive particles can be more efficiently placed on the electrode, and the conduction reliability further increases.

The average particle diameter of the conductive particles indicates a number average particle diameter. The average particle diameter of conductive particles is determined by, for example, observing arbitrary 50 conductive particles with an electron microscope or an optical microscope and calculating an average value, or performing laser diffraction type particle size distribution measurement.

The variation coefficient of the particle diameter of the conductive particles is preferably 5% or more, more preferably 10% or more, and preferably 40% or less, more preferably 30% or less. When the variation coefficient of the particle diameter is not less than the above lower limit and not more than the above upper limit, the solder can be more efficiently placed on the electrode. However, the variation coefficient of the particle diameter of the conductive particles may be less than 5%.

The variation coefficient (CV value) can be measured as follows.

CV value (%)=(ρ/Dn)×100
ρ: standard deviation of particle diameter of conductive particles
Dn: average value of particle diameter of conductive particles

The shape of the conductive particles is not particularly limited. The shape of the conductive particles may be spherical, and may have a shape other than a spherical shape, such as a flat shape.

The content of the conductive particles in 100% by weight of the conductive material is preferably 30% by weight or more, more preferably 40% by weight or more, further preferably 50% weight or more, and preferably 95% by weight or less, more preferably 90% by weight or less. When the content of the conductive particles is not less than the above lower limit and not more than the above upper limit, the conductive particles can be more efficiently placed on the electrode, it is easy to place more solder of the conductive particles between the electrodes, and the conduction reliability further increases. From the viewpoint of further increasing the conduction reliability, it is more preferable as the content of the conductive particles is larger.

(Curable Component: Curable Compound)

Examples of the curable compound include a thermosetting compound and a photocurable compound. The curable compound is preferably a thermosetting compound. The thermosetting compound is a compound curable by heating. Examples of the thermosetting compound include oxetane compounds, epoxy compounds, episulfide compounds, (meth)acrylic compounds, phenol compounds, amino compounds, unsaturated polyester compounds, polyurethane compounds, silicone compounds and polyimide compounds. From the viewpoint of further improving the curability and viscosity of the conductive material and further enhancing the conduction reliability, the curable compound is preferably an epoxy compound or an episulfide compound, more preferably the epoxy compound. The conductive material preferably contains an epoxy compound. One kind of the thermosetting compound may be used alone, and two or more kinds thereof may be used in combination.

The epoxy compound is preferably an aromatic epoxy compound such as a resorcinol type epoxy compound, a naphthalene type epoxy compound, a biphenyl type epoxy compound, a benzophenone type epoxy compound, or a phenol novolak type epoxy compound. An epoxy compound whose melting temperature is not higher than the melting point of solder is preferable. The melting temperature is preferably 100° C. or lower, more preferably 80° C. or lower, further preferably 40° C. or lower. When the above preferable epoxy compound is used, the viscosity is high at the time of laminating the connection object member, and when acceleration is applied by shocks of moving or the like, positional displacement between the first connection object member and the second connection object member can be suppressed. Further, by using the preferred epoxy compound, the viscosity can be greatly lowered by heat at the time of curing, and aggregation of the solder of the conductive particles can proceed efficiently.

The content of the curable compound in 100% by weight of the conductive material is preferably 5% by weight or more, more preferably 8% by weight or more, further preferably 10% by weight or more, and preferably 60% by weight or less, more preferably 55% by weight or less, further preferably 50% by weight or less, particularly preferably 40% by weight or less. When the content of the curable compound is not less than the above lower limit and not more than the above upper limit, it is possible to more efficiently place the conductive particles on the electrode, further suppress positional displacement between the electrodes, and further enhance the conduction reliability between the electrodes. From the viewpoint of further increasing the impact resistance, it is more preferable as the content of the thermosetting compound is larger.

(Curable Component: Thermosetting Agent)

It is preferable that the conductive material according to the present invention does not contain a thermosetting agent. The conductive material according to the present invention may contain a thermosetting compound and a thermosetting agent. The thermosetting agent thermally cures the thermosetting compound. Examples of the thermosetting agent include a thiol curing agent such as an imidazole curing agent, an amine curing agent, a phenol curing agent, and a polythiol curing agent, an acid anhydride curing agent, a thermal cationic initiator (thermal cationic curing agent), and a thermal radical generator. One kind of the thermosetting agents may be used alone, and two or more kinds thereof may be used in combination. When the conductive material according to the present invention contains the thermosetting agent, the content of the thermosetting agent is preferably less than 1 part by weight, more preferably less than 0.1 parts by weight, further preferably less than 0.05 parts by weight, based on 100 parts by weight of the thermosetting compound. It is particularly preferable that the content of the thermosetting agent is 0 parts by weight (not contained) based on 100 parts by weight of the thermosetting compound. If the content of the thermosetting agent is the above preferred content, even when the conductive material is left for a certain period of time, the solder of the conductive particles can be efficiently placed on the electrode, and, in addition, yellowing of the conductive material can be sufficiently suppressed during heating.

Even when the conductive material is left for a certain period of time, from the viewpoint of more efficiently placing the conductive particles on the electrode, it is preferable that the thermosetting agent is not a thiol curing agent.

From the viewpoint of further suppressing the yellowing of the conductive material during heating, it is preferable that the thermosetting agent is not an imidazole curing agent. When the conductive material according to the present invention contains the imidazole thermosetting agent, the content of the imidazole thermosetting agent is preferably less than 1 part by weight, more preferably less than 0.1 parts by weight, further preferably less than 0.05 parts by weight, based on 100 parts by weight of the thermosetting compound. It is particularly preferable that the content of the imidazole thermosetting agent is 0 parts by weight (not contained) based on 100 parts by weight of the thermosetting compound. If the content of the imidazole thermosetting agent is the preferred content, even when the conductive material is left for a certain period of time, the solder of the conductive particles can be efficiently placed on the electrode, and, in addition, yellowing of the conductive material can be sufficiently suppressed during heating.

The imidazole curing agent is not particularly limited. Examples of the imidazole curing agent include 2-methylimidazole, 2-ethyl-4-methylimidazole, 1-cyanoethyl-2-phenylimidazole, l-cyanoethyl-2-phenylimidazolium trimellitate, 2,4-diamino-6-[2′-methylimidazolyl-(1′)]-ethyl-s-triazine, and 2,4-diamino-6-[2′-methylimidazolyl-(1′)]-ethyl-s-triazine isocyanuric acid adduct.

The thiol curing agent is not particularly limited. Examples of the thiol curing agent include trimethylolpropane tris-3-mercaptopropionate, pentaerythritol tetrakis-3-mercaptopropionate and dipentaerythritol hexa-3-mercaptopropionate.

The amine curing agent is not particularly limited. Examples of the amine curing agent include hexamethylenediamine, octamethylenediamine, decamethylenediamine, 3,9-bis(3-aminopropyl)-2,4,8,10-tetraspiro[5.5]undecane, bis(4-aminocyclohexyl)methane, metaphenylenediamine and diaminodiphenyl sulfone.

Examples of the thermal cationic initiator (thermal cationic curing agent) include iodonium-based cationic curing agents, oxonium-based cationic curing agents and sulfonium-based cationic curing agents. Examples of the iodonium-based cationic curing agent include bis(4-tert-butylphenyl)iodonium hexafluorophosphate. Examples of the oxonium-based cationic curing agent include trimethyloxonium tetrafluoroborate. Examples of the sulfonium-based cationic curing agent include tri-p-tolylsulfonium hexafluorophosphate.

The thermal radical generator is not particularly limited. Examples of the thermal radical generator include azo compounds and organic peroxides. Examples of the azo compound include azobisisobutyronitrile (AIBN). Examples of the organic peroxide include di-tert-butyl peroxide and methyl ethyl ketone peroxide.

The reaction initiation temperature of the thermosetting agent is preferably 50° C. or higher, more preferably 60° C. or higher, further preferably 70° C. or higher, and preferably 250° C. or lower, more preferably 200° C. or lower, further preferably 190° C. or lower, particularly preferably 180° C. or lower. When the reaction initiation temperature of the thermosetting agent is not lower than the above lower limit and not higher than the above upper limit, the conductive particles are more efficiently placed on the electrode.

The content of the thermosetting agent is not particularly limited. The content of the thermosetting agent is preferably 0.01 parts by weight or more, more preferably 1 parts by weight or more, and preferably 200 parts by weight or less, more preferably 100 parts by weight or less, further preferably 75 parts by weight or less based on 100 parts by weight of the thermosetting compound. When the content of the thermosetting agent is not less than the above lower limit, it is easy to sufficiently cure the conductive material. When the content of the thermosetting agent is not more than the above upper limit, excessive thermosetting agent that is not involved in curing hardly remains after curing, and heat resistance of a cured product is further enhanced.

(Boron Trifluoride Complex)

The conductive material according to the present invention contains a boron trifluoride complex. One kind of the boron trifluoride complex may be used alone, and two or more kinds thereof may be used in combination.

In the conductive material according to the present invention, it is preferable that the boron trifluoride complex acts as a curing accelerator for the curable compound. It is preferable that the conductive material does not contain the thermosetting agent, and it is preferable that the curable compound is cured singly by the boron trifluoride complex. It is preferable that the curable compound is homopolymerized by the boron trifluoride complex. It is preferable that the curable compound alone reacts with the boron trifluoride complex to form a cured product. In a cured product of the conductive material, it is preferable that a plurality of the curable compounds are bonded to each other. In such a case, even when the conductive material is left for a certain period of time, the conductive particles can be efficiently placed on the electrode, so that the conduction reliability between the electrodes can be sufficiently enhanced.

Preferred examples of the boron trifluoride complex include boron trifluoride-amine complex. The boron trifluoride-amine complex is a complex of boron trifluoride and an amine compound. The amine compound may be a cyclic amine. One kind of the boron trifluoride-amine complex may be used alone, and two or more kinds thereof may be used in combination.

Examples of the boron trifluoride-amine complex include boron trifluoride-monoethylamine complex, boron trifluoride-piperidine complex, boron trifluoride-triethylamine complex, boron trifluoride-aniline complex, boron trifluoride-diethyl amine complex, boron trifluoride-isopropylamine complex, boron trifluoride-chlorophenyl amine complex, boron trifluoride-benzyl amine complex, and boron trifluoride-monopentyl amine complex.

Even when the conductive material is left for a certain period of time, from the viewpoint of more efficiently placing the conductive particles on the electrode, the boron trifluoride complex is preferably a boron trifluoride-monoethylamine complex.

The content of the boron trifluoride complex in 100% by weight of the conductive material is preferably 0.1% by weight or more, more preferably 0.2% by weight or more, and preferably 1.5% by weight or less, more preferably 1.0% by weight or less. If the content of the boron trifluoride complex is not less than the above lower limit and not more than the above upper limit, even when the conductive material is left for a certain period of time, the conductive particles can be more efficiently placed on the electrode, it is easy to place more solder of the conductive particles between the electrodes, and the conduction reliability further increases.

(Flux)

The conductive material preferably contains a flux. By using the flux, the solder of the conductive particles can be more effectively placed on the electrode. The flux is not particularly limited. As the flux, fluxes that are generally used for solder joint can be used.

Examples of the flux include zinc chloride, mixtures of zinc chloride and an inorganic halide, mixtures of zinc chloride and an inorganic acid, molten salts, phosphoric acid, derivatives of phosphoric acid, organic halides, hydrazine, organic acids and pine resins. One kind of the flux may be used alone, and two or more kinds thereof may be used in combination.

Examples of the molten salt include ammonium chloride. Examples of the organic acid include lactic acid, citric acid, stearic acid, glutamic acid, malic acid and glutaric acid. Examples of the pine resin include an activated pine resin and a non-activated pine resin. The flux is preferably an organic acid having two or more carboxyl groups or a pine resin. The flux may be an organic acid having two or more carboxyl groups or a pine resin. By using the organic acid having two or more carboxyl groups, or the pine resin, the conduction reliability between the electrodes further increases.

The pine resin is a rosin having abietic acid as a main component. The flux is preferably a rosin, and more preferably abietic acid. When this preferable flux is used, the conduction reliability between electrodes further increases.

The activation temperature (melting point) of the flux is preferably 50° C. or higher, more preferably 70° C. or higher, further preferably 80° C. or higher, and preferably 200° C. or lower, more preferably 190° C. or lower, still more preferably 160° C. or lower, even more preferably 150° C. or lower, further more preferably 140° C. or lower. When the activation temperature of the flux is not lower than the above lower limit and not higher than the above upper limit, the flux effect is more effectively exhibited, and the solder of the conductive particles is more efficiently placed on the electrode. The activation temperature (melting point) of the flux is preferably 80° C. or higher and 190° C. or lower. The activation temperature (melting point) of the flux is particularly preferably 80° C. or higher and 140° C. or lower.

Examples of the flux having an activation temperature (melting point) of 80° C. or higher and 190° C. or lower include dicarboxylic acids such as succinic acid (melting point 186° C.), glutaric acid (melting point 96° C.), adipic acid (melting point 152° C.), pimelic acid (melting point 104° C.), and suberic acid (melting point 142° C.), benzoic acids (melting point 122° C.), and malic acids (melting point 130° C.).

The boiling point of the flux is preferably 200° C. or lower.

The flux is preferably a flux that releases cations by heating. By using the flux that releases cations by heating, the solder of the conductive particles can be more efficiently placed on the electrode.

Examples of the flux that releases cations by heating include the thermal cationic initiator (thermal cationic curing agent).

The flux is more preferably a salt of an acid compound and a base compound. The acid compound preferably has an effect of cleaning a metal surface, and the base compound preferably has an action of neutralizing the acid compound. The flux is preferably a neutralization reaction product of the acid compound and the base compound. One kind of the flux may be used alone, and two or more kinds thereof may be used in combination.

The melting point of the flux is preferably 60° C. or higher, more preferably 80° C. or higher. When the melting point of the flux is not lower than the above lower limit, storage stability of the flux is further enhanced.

From the viewpoint of more efficiently placing the solder of the conductive particles on the electrode, the melting point of the flux is preferably lower than the melting point of the solder of the conductive particles, more preferably lower by 5° C. or higher, further preferably by 10° C. or higher, than the melting point of the solder. However, the melting point of the flux may be higher than the melting point of the solder of the conductive particles. The use temperature of the conductive material is usually not lower than the melting point of the solder of the conductive particles, and when the melting point of the flux is not higher than the use temperature of the conductive material, even if the melting point of the flux is higher than the melting point of the solder of the conductive particles, the flux can sufficiently exhibit the performance as a flux. For example, the use temperature of the conductive material is 150° C. or higher, and in a conductive material containing solder (Sn42Bi58: melting point 139° C.) in the conductive particles and a flux (melting point 146° C.) which is a salt of malic acid and benzylamine, the flux which is the salt of malic acid and benzylamine exhibits a sufficient flux effect.

From the viewpoint of more efficiently placing the solder of the conductive particles on the electrode, the melting point of the flux is preferably lower than the reaction initiation temperature of the curable compound, more preferably lower by 5° C. or higher, further preferably by 10° C. or higher, than the reaction initiation temperature of the curable compound.

The acid compound is preferably an organic compound having a carboxyl group. Examples of the acid compound include aliphatic carboxylic acids such as malonic acid, succinic acid, glutaric acid, adipic acid, pimelic acid, suberic acid, azelaic acid, sebacic acid, citric acid, and malic acid, cycloaliphatic carboxylic acids such as cyclohexyl carboxylic acid and 1,4-cyclohexyl dicarboxylic acid, and aromatic carboxylic acids such as isophthalic acid, terephthalic acid, trimellitic acid, and ethylenediaminetetraacetic acid. The acid compound is preferably glutaric acid, azelaic acid, or malic acid.

The base compound is preferably an organic compound having an amino group. Examples of the base compound include diethanolamine, triethanolamine, methyldiethanolamine, ethyldiethanolamine, cyclohexylamine, dicyclohexylamine, benzylamine, benzhydrylamine, 2-methylbenzylamine, 3-methylbenzylamine, 4-tert-butylbenzylamine, N-methylbenzylamine, N-ethylbenzylamine, N-phenylbenzylamine, N-tert-butylbenzylamine, N-isopropylbenzylamine, N,N-dimethylbenzylamine, imidazole compounds, and triazole compounds. The base compound is preferably benzylamine, 2-methylbenzylamine, or 3-methylbenzylamine.

The flux may be dispersed in the conductive material or may be attached on the surface of the conductive particles. From the viewpoint of more effectively enhancing the flux effect, it is preferable that the flux is attached on the surface of the conductive particles.

From the viewpoint of further enhancing storage stability of the conductive material and also from the viewpoint of exhibiting excellent solder aggregation even when the conductive material is left for a certain period of time and more efficiently placing the solder of the conductive particles on the electrode, the flux is preferably a solid at 25° C., and it is preferable that the flux is dispersed as a solid in the conductive material at 25° C.

The content of the flux in 100% by weight of the conductive material is preferably 0.1% by weight or more, and preferably 20% by weight or less, more preferably 10% by weight or less. When the content of the flux is not less than the above lower limit and not more than the above upper limit, it is more difficult for an oxide film to be formed on the solder and the electrode surface, and, in addition, the oxide film formed on the solder and the electrode surface can be more effectively removed.

(Filler)

A filler may be added to the conductive material. The filler may be an organic filler or an inorganic filler. The addition of the filler can uniformly aggregate the conductive particles on all the electrodes on the substrate.

It is preferable that the conductive material does not contain the filler or contains the filler in an amount of 5% by weight or less. When a crystalline thermosetting compound is used, as the content of the filler is smaller, the solder more easily moves on the electrode.

The content of the filler in 100% by weight of the conductive material is preferably 0% by weight (not contained) or more, and preferably 5% by weight or less, more preferably 2% by weight or less, further preferably 1% by weight or less. When the content of the filler is not less than the above lower limit and not more than the above upper limit, the conductive particles are more efficiently placed on the electrode.

(Other Components)

If necessary, the conductive material may contain various additives such as a filler, an extender, a softener, a plasticizer, a polymerization catalyst, a curing catalyst, a colorant, an antioxidant, a thermal stabilizer, a light stabilizer, an ultraviolet absorber, a lubricant, an antistatic agent, and a flame retardant.

(Connection Structure and Method for Producing Connection Structure)

A connection structure according to the present invention includes a first connection object member having at least one first electrode on its surface, a second connection object member having at least one second electrode on its surface, and a connection portion connecting the first connection object member and the second connection object member. In the connection structure according to the present invention, the material of the connection portion is the above-described conductive material. In the connection structure according to the present invention, the first electrode and the second electrode are electrically connected by a solder portion in the connection portion.

A method for producing a connection structure according to the present invention includes a process of placing the conductive material on a surface of a first connection object member, having at least one first electrode on its surface, with the use of the above-described conductive material. The method for producing a connection structure according to the present invention includes a process of disposing a second connection object member, having at least one second electrode on its surface, on a surface opposite to the first connection object member side of the conductive material such that the first electrode and the second electrode face each other. The method for producing a connection structure according to the present invention includes a process of heating the conductive material to a temperature not lower than a melting point of solder of the conductive particles to form a connection portion, connecting the first connection object member and the second connection object member, with the conductive material and electrically connecting the first electrode and the second electrode via a solder portion in the connection portion.

In the connection structure and the method for producing a connection structure according to the present invention, since a specific conductive material is used, the solder of the conductive particles is likely to gather between the first electrode and the second electrode, and the solder can be efficiently placed on the electrode (line). In addition, it is difficult for a portion of the solder to be placed in a region (space) where no electrode is formed, and the amount of the solder placed in the region where no electrode is formed can be considerably reduced. Accordingly, the conduction reliability between the first electrode and the second electrode can be enhanced. In addition, it is possible to prevent electrical connection between electrodes that must not be connected and are adjacent in a lateral direction, and insulation reliability can be enhanced.

In order to efficiently place the solder of the conductive particles on the electrode and considerably reduce the amount of the solder placed in the region where no electrode is formed, preferably the conductive material is not a conductive film, and a conductive paste is used.

The thickness of the solder portion between the electrodes is preferably 10 μm or more, more preferably 20 μm or more, and preferably 100 μm or less, more preferably 80 μm or less. A solder wetting area on the surface of the electrode (an area where the solder is in contact in 100% of the exposed area of the electrode) is preferably 50% or more, more preferably 60% or more, further preferably 70% or more, and preferably 100% or less.

Hereinafter, specific embodiments of the present invention will be described with reference to the drawings.

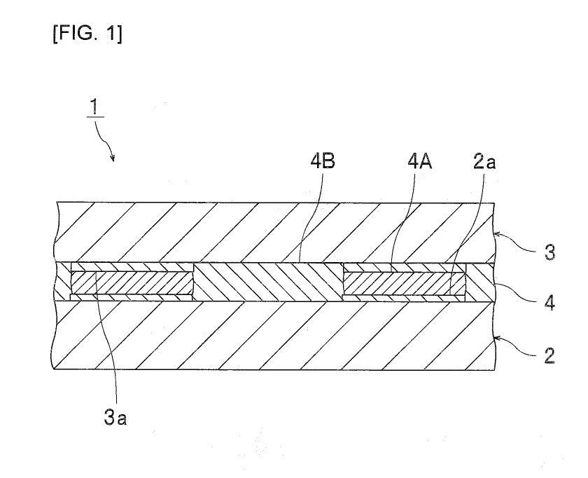

FIG. 1 is a cross-sectional view schematically showing a connection structure obtained using a conductive material according to one embodiment of the present invention.

A connection structure 1 shown in FIG. 1 includes a first connection object member 2, a second connection object member 3, and a connection portion 4 connecting the first connection object member 2 and the second connection object member 3. The connection portion 4 is formed of the above-described conductive material. In the present embodiment, the conductive material contains conductive particles, a curable compound, and a boron trifluoride complex. In the present embodiment, the curable compound includes a thermosetting compound. In the present embodiment, the conductive material contains solder particles as the conductive particles. The thermosetting compound and the boron trifluoride complex are each referred to as a thermosetting component (curable component).

The connection portion 4 has a solder portion 4A in which a plurality of solder particles gather and are bonded to each other and a cured product portion 4B in which a thermosetting component is thermally cured.

The first connection object member 2 has a plurality of first electrodes 2a on its surface (upper surface). The second connection object member 3 has a plurality of second electrodes 3a on its surface (lower surface). The first electrode 2a and the second electrode 3a are electrically connected by the solder portion 4A. Accordingly, the first connection object member 2 and the second connection object member 3 are electrically connected by the solder portion 4A. In the connection portion 4, no solder exists in a region (a site of the cured product portion 4B) different from the solder portion 4A gathering between the first electrode 2a and the second electrode 3a. In the region (the site of the cured product portion 4B) different from the solder portion 4A, there is no solder away from the solder portion 4A. A small amount of solder may exist in the region (the site of the cured product portion 4B) different from the solder portion 4A gathering between the first electrode 2a and the second electrode 3a.

As shown in FIG. 1, in the connection structure 1, a plurality of solder particles gather between the first electrode 2a and the second electrode 3a, and after the plurality of solder particles melt, a melt of the solder particles is wetted and spreads over the surface of the electrode and is then solidified to form the solder portion 4A. Thus, a connection area between the solder portion 4A and the first electrode 2a and a connection area between the solder portion 4A and the second electrode 3a increase. That is, by using the solder particles, the contact area of the solder portion 4A and the first electrode 2a and the contact area of the solder portion 4A and the second electrode 3a are large as compared to a case where a conductive particle with an outer surface portion of a conductive portion formed of a metal such as nickel, gold or copper is used. Thus, the conduction reliability and the connection reliability in the connection structure 1 are enhanced. The conductive material may contain a flux. When the flux is used, heating causes the flux to be gradually deactivated.

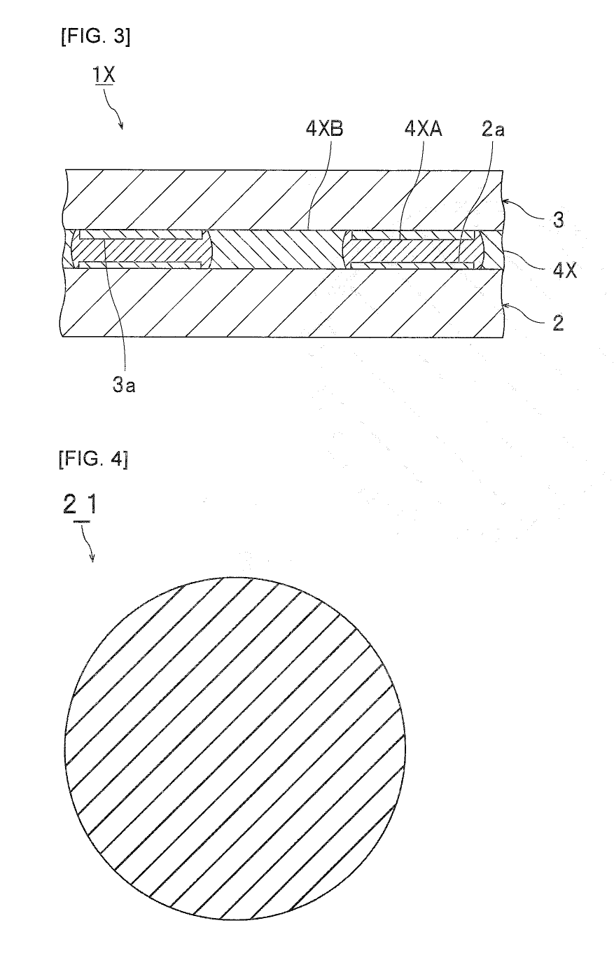

In the connection structure 1 shown in FIG. 1, all of the solder portions 4A are located in a region where the first and second electrodes 2a and 3a face each other. In a connection structure 1X of the modified example shown in FIG. 3, only a connection portion 4X differs from the connection structure 1 shown in FIG. 1. The connection portion 4X has a solder portion 4XA and a cured product portion 4XB. As in the connection structure 1X, most of the solder portion 4XA is located in a region where the first and second electrodes 2a and 3a face each other, and a portion of the solder portion 4XA may protrude laterally from the region where the first and second electrodes 2a and 3a face each other. The solder portion 4XA protruding laterally from the region where the first and second electrodes 2a and 3a face each other is a portion of the solder portion 4XA and is not solder away from the solder portion 4XA. In the present embodiment, the amount of solder away from the solder portion can be reduced; however, solder away from the solder portion may exist in a cured product portion.

The connection structure 1 can be easily obtained by reducing the use amount of solder particles. The connection structure 1X can be easily obtained by increasing the use amount of solder particles.

When viewing a portion where the first electrode and the second electrode face each other in a stacking direction of the first electrode, the connection portion, and the second electrode, it is preferable that the solder portion in the connection portion is placed in 50% or more of 100% of the area of the portion where the first electrode and the second electrode face each other. When viewing a portion where the first electrode and the second electrode face each other in a stacking direction of the first electrode, the connection portion, and the second electrode, it is more preferable that the solder portion in the connection portion is placed in 60% or more of 100% of the area of the portion where the first electrode and the second electrode face each other. When viewing a portion where the first electrode and the second electrode face each other in a stacking direction of the first electrode, the connection portion, and the second electrode, it is further preferable that the solder portion in the connection portion is placed in 70% or more of 100% of the area of the portion where the first electrode and the second electrode face each other. When viewing a portion where the first electrode and the second electrode face each other in a stacking direction of the first electrode, the connection portion, and the second electrode, it is particularly preferable that the solder portion in the connection portion is placed in 80% or more of 100% of the area of the portion where the first electrode and the second electrode face each other. When viewing a portion where the first electrode and the second electrode face each other in a stacking direction of the first electrode, the connection portion, and the second electrode, it is most preferable that the solder portion in the connection portion is placed in 90% or more of 100% of the area of the portion where the first electrode and the second electrode face each other. By satisfying the above preferable aspect, the conduction reliability can be further enhanced.

Next, an example of a method for producing the connection structure 1 using the conductive material according to one embodiment of the present invention will be described.

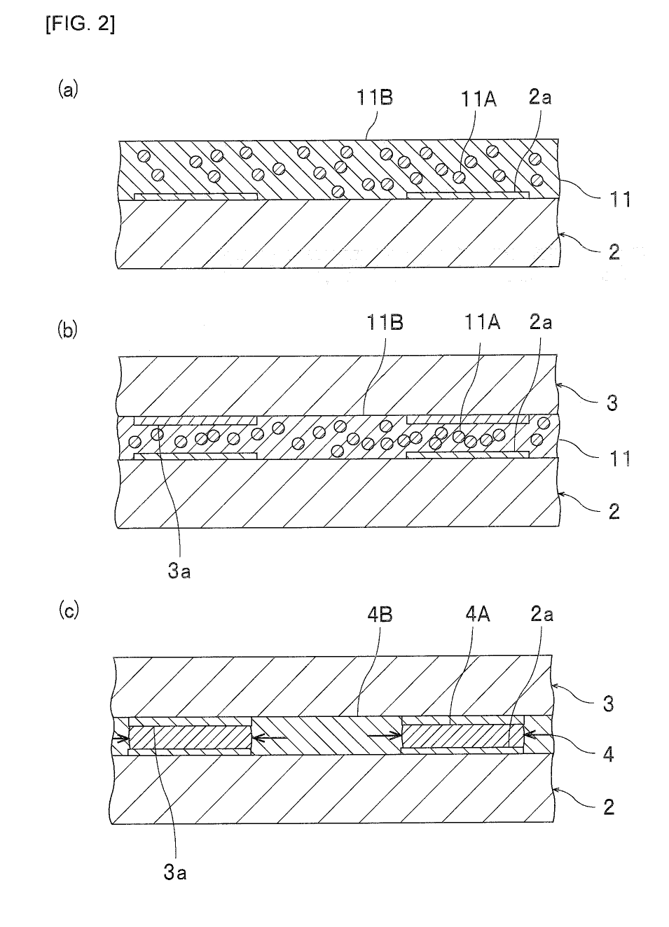

First, the first connection object member 2 having the first electrode 2a on its surface (upper surface) is prepared. Then, as shown in FIG. 2(a), a conductive material 11 containing a thermosetting component 11B and a plurality of solder particles 11A is placed on the surface of the first connection object member 2 (first process).

The conductive material 11 contains a thermosetting compound and a boron trifluoride complex as the thermosetting component 11B.

The conductive material 11 is placed on the surface of the first connection object member 2 on which the first electrode 2a is provided. After the conductive material 11 is placed thereon, the solder particles 11A are arranged both on the first electrode 2a (line) and on a region (space) where the first electrode 2a is not formed.

Although the method for placing the conductive material 11 is not particularly limited, application by a dispenser, screen printing, discharge by an inkjet apparatus, and the like can be adopted.

On the other hand, the second connection object member 3 having the second electrode 3a on its surface (lower surface) is prepared. Then, as shown in FIG. 2(b), in the conductive material 11 on the surface of the first connection object member 2, the second connection object member 3 is placed on a surface of the conductive material 11, which is opposite to the first connection object member 2 side (second process). The second connection object member 3 is placed on the surface of the conductive material 11 from the second electrode 3a side. At this time, the first electrode 2a and the second electrode 3a face each other.

Then, the conductive material 11 is heated to a temperature not lower than the melting point of the solder particles 11A (third process). Preferably, the conductive material 11 is heated to a temperature not lower than the curing temperature of the thermosetting component 11B (thermosetting compound). During this heating, the solder particles 11A existing in the region where no electrode is formed gather between the first electrode 2a and the second electrode 3a (self-aggregation effect). When a conductive paste is used instead of a conductive film, the solder particles 11A effectively gather between the first electrode 2a and the second electrode 3a. The solder particles 11A melt and are bonded to each other. The thermosetting component 11B is thermally cured. As a result, as shown in FIG. 2(c), the connection portion 4 connecting the first connection object member 2 and the second connection object member 3 is formed by the conductive material 11. The connection portion 4 is formed by the conductive material 11, the solder portion 4A is formed by bonding the plurality of solder particles 11A, and the thermosetting component 11B is thermally cured to form the cured product portion 4B. The cured product portion 4B is a cured product obtained by curing a thermosetting compound singly with a boron trifluoride complex. If the solder particles 11A move sufficiently, it is not necessary to keep temperature constant from a start of movement of the solder particles 11A not located between the first electrode 2a and the second electrode 3a to completion of movement of the solder particles 11A between the first electrode 2a and the second electrode 3a.

In the present embodiment, the conductive material 11 has the above-described configuration. Even if the state of FIG. 2(a) is maintained for a certain period of time after the conductive material 11 is placed on the surface of the first connection object member 2 on which the first electrode 2a is provided, when the conductive material 11 is heated in the third process, the solder particles 11A existing in the region where no electrode is formed can gather between the first electrode 2a and the second electrode 3a without any problem.

When a conductive material without the above-described configuration is used, particularly when a thermosetting agent is contained, the conductive material is disposed on the surface of the first connection object member on which the first electrode is provided, and then, when the state of FIG. 2(a) is maintained for a certain period of time, the surface of the solder particles is for example oxidized by the thermosetting agent. Thus, when the conductive material is heated in the third process, the solder particles existing in the region where no electrode is formed cannot sufficiently gather between the first electrode and the second electrode, and the solder particles may be left behind in a cured product portion. Accordingly, it may be unable to sufficiently enhance the conduction reliability between the electrodes. In addition, the electrodes that must not be connected and are adjacent in a lateral direction are electrically connected, and it may be unable to sufficiently enhance the insulation reliability.

In the present embodiment, it is preferable not to perform pressurization in the second process and the third process. In this case, the weight of the second connection object member 3 is added to the conductive material 11. Thus, when the connection portion 4 is formed, the solder particles 11A effectively gather between the first electrode 2a and the second electrode 3a. If pressurization is performed in at least one of the second process and the third process, there is a high tendency that the action of the solder particles gathering between the first electrode and the second electrode is hindered.

In the present embodiment, since pressurization is not performed, when the second connection object member is superimposed on the first connection object member coated with the conductive material, even in a misalignment state between the first electrode and the second electrode, the misalignment can be corrected, and the first electrode and the second electrode can be connected (self-alignment effect). This is because the case where an area where solder between the first electrode and the second electrode is in contact with other components of the conductive material is minimum results in more stabilization in terms of energy of molten solder self-aggregated between the first electrode and the second electrode, so that a force for forming a connection structure suitable for alignment which is a connection structure with the minimum area is applied. In this case, it is desirable that the conductive material is not cured, and the viscosity of components other than the conductive particles of the conductive material is sufficiently low at the temperature and time.

The viscosity of the conductive material at the melting point of the solder is preferably 50 Pa·s or less, more preferably 10 Pa·s or less, further preferably 1 Pa·s or less, and preferably 0.1 Pa·s or more, more preferably 0.2 Pa·s or more. When the viscosity is not more than the above upper limit, the solder of the conductive particles can efficiently aggregate. When the viscosity is not less than the above lower limit, voids in the connection portion are suppressed, and it is possible to prevent the conductive material from protruding to portions other than the connection portion.

The viscosity of the conductive material at the melting point of the solder is measured as follows.

The viscosity of the conductive material at the melting point of the solder can be measured using STRESSTECH (manufactured by EOLOGICA) or the like under conditions of a strain control of 1 rad, a frequency of 1 Hz, a temperature rising rate of 20° C./min, and a measurement temperature range of 25 to 200° C. (provided that the temperature upper limit is taken as the melting point of the solder when the melting point of the solder is higher than 200° C.). From the measurement results, the viscosity at the melting point (° C.) of the solder is evaluated.

Thus, the connection structure 1 shown in FIG. 1 is obtained. The second process and the third process may be performed continuously. After the second process is performed, a stack of the first connection object member 2, the conductive material 11, and the second connection object member 3, to be obtained, is moved to a heating section, and the third process may be performed. In order to perform the heating, the stack may be placed on a heating member, and the stack may be placed in a heated space.

The heating temperature in the third process is preferably 140° C. or higher, more preferably 160° C. or higher, and preferably 450° C. or lower, more preferably 250° C. or lower, further preferably 200° C. or lower.

Examples of the heating method in the third process include a method of heating the entire connection structure in a reflow oven or an oven to a temperature not lower than the melting point of solder of the conductive particles and a temperature not lower than the curing temperature of the thermosetting component, and a method of locally heating only the connection portion of the connection structure.

Examples of instruments used for the local heating method include a hot plate, a heat gun for applying hot air, a soldering iron, and an infrared heater.

When local heating is performed using a hot plate, it is preferable that directly under the connection portion, an upper surface of the hot plate is formed with a metal with a high thermal conductivity, and in other portions not preferable to be heated, the upper surface of the hot plate is formed with a material with a low thermal conductivity such as a fluororesin.

The first and second connection object members are not particularly limited. Specific examples of the first and second connection object members include electronic components such as a semiconductor chip, a semiconductor package, an LED chip, an LED package, a capacitor and a diode, and electronic components such as a resin film, a printed board, a flexible printed board, a flexible flat cable, a rigid flexible substrate, a glass epoxy substrate, and a circuit board such as a glass substrate. The first and second connection object members are preferably electronic components.

It is preferable that at least one of the first connection object member and the second connection object member is a resin film, a flexible printed board, a flexible flat cable or a rigid flexible substrate. The second connection object member is preferably a resin film, a flexible printed board, a flexible flat cable or a rigid flexible substrate. The resin film, the flexible printed board, the flexible flat cable and the rigid flexible substrate have high flexibility and relatively light weight. When a conductive film is used to connect such a connection object member, there is a tendency that solder is less likely to gather on the electrode. On the other hand, by using a conductive paste, even if a resin film, a flexible printed board, a flexible flat cable or a rigid flexible substrate is used, solder is efficiently gathered on the electrode, whereby the conduction reliability between the electrodes can be sufficiently enhanced. When a resin film, a flexible printed board, a flexible flat cable or a rigid flexible substrate is used, compared to the case of using other connection object members such as a semiconductor chip, the conduction reliability between the electrodes due to no pressurization can be obtained more effectively.

Examples of the electrode provided on the connection object member include metal electrodes such as a gold electrode, a nickel electrode, a tin electrode, an aluminum electrode, a copper electrode, a molybdenum electrode, a silver electrode, a SUS electrode, and a tungsten electrode. When the connection object member is a flexible printed board, the electrode is preferably a gold electrode, a nickel electrode, a tin electrode, a silver electrode or a copper electrode. When the connection object member is a glass substrate, the electrode is preferably an aluminum electrode, a copper electrode, a molybdenum electrode, a silver electrode or a tungsten electrode. When the electrode is an aluminum electrode, it may be an electrode formed only of aluminum, or may be an electrode with an aluminum layer stacked on the surface of a metal oxide layer. Examples of the material of the metal oxide layer include indium oxide doped with a trivalent metal element and zinc oxide doped with a trivalent metal element. Examples of the trivalent metal element include Sn, Al, and Ga.

The present invention will be specifically described below by way of Examples and Comparative Examples. The present invention is not limited only to the following examples.

Thermosetting component (thermosetting compound):

“D.E.N-431” manufactured by Dow Chemical Company, epoxy resin

“jER 152” manufactured by Mitsubishi Chemical Corporation, epoxy resin

Thermosetting component (thermosetting agent):

“TMTP” manufactured by Yodo Kagaku Co., Ltd., trimethylolpropane tris thiopropionate

“HN-5500” manufactured by Hitachi Chemical Co., Ltd., 3- or 4-methyl-hexahydrophthalic anhydride

Boron Trifluoride Complex:

“BF3-MEA” manufactured by Stella Chemifa Corporation, boron trifluoride-monoethylamine complex

“BF3-PIP” manufactured by Stella Chemifa Corporation, boron trifluoride-piperidine complex

“BF3-TEA”, boron trifluoride-triethylamine complex

(Synthesis of “BF3-TEA”)

Boron trifluoride-triethylamine complex was obtained by reacting triethylamine and BF3-etherate in ether and purifying by vacuum distillation.

Imidazole Compound:

“2PZ-CN” manufactured by Shikoku Chemicals Corporation, l-cyanoethyl-2-phenylimidazole

“2E4MZ” manufactured by Shikoku Chemicals Corporation, 2-ethyl-4-methylimidazole

Flux:

Salt formed by a neutralization reaction at a 1:1 molar ratio of “glutaric acid” and “benzylamine” manufactured by Wako Pure Chemical Industries, Ltd.

Conductive Particles:

Solder particles “Sn42Bi58 (DS-10)” manufactured by Mitsui Mining & Smelting Co., Ltd.

### Examples 1 to 4 and Comparative Examples 1 to 3

(1) Preparation of Anisotropic Conductive Paste

Components shown in Table 1 below were compounded in blending amounts shown in Table 1 to obtain an anisotropic conductive paste

(2) Production of First Connection Structure (L/S=50 μm/50 μm)

(Specific Method for Producing Connection Structure Under Condition A)

A first connection structure was produced as follows by using the anisotropic conductive paste immediately after production.

A glass epoxy board (FR-4 substrate) (first connection object member) having on its upper surface a copper electrode pattern (copper electrode thickness: 12 μm) having L/S of 50 μm/50 μm and an electrode length of 3 mm was prepared. In addition, a flexible printed board (second connection object member) having on its lower surface a copper electrode pattern (copper electrode thickness: 12 μm) having L/S of 50 m/50 μm and an electrode length of 3 mm was prepared.

A superimposed area of the glass epoxy board and the flexible printed board was 1.5 cm×3 mm, and the number of connected electrodes was 75 pairs.

The anisotropic conductive paste immediately after being prepared was applied to the upper surface of the glass epoxy board to make thickness of 100 μm on the electrode of the glass epoxy board with the use of a metal mask by screen printing to form an anisotropic conductive paste layer. Then, the flexible printed board was stacked on the upper surface of the anisotropic conductive paste layer such that the electrodes faced each other. At this time, pressurization was not performed. The weight of the flexible printed board is added to the anisotropic conductive paste layer. Thereafter, solder was melted while heating was performed such that the temperature of the anisotropic conductive paste layer increased to 190° C., and the anisotropic conductive paste layer was cured at 190° C. for 10 seconds to obtain the first connection structure.

(Specific Method for Producing Connection Structure Under Condition B)

A first connection structure was produced in the same manner as the condition A except that the following changes were made.

Changes from Condition A to Condition B:

The anisotropic conductive paste immediately after being prepared was applied to the upper surface of the glass epoxy board to make thickness of 100 μm on the electrode of the glass epoxy board with the use of a metal mask by screen printing to form an anisotropic conductive paste layer, and then the anisotropic conductive paste layer was left for 12 hours at 23° C. and 50% RH in the air atmosphere. After leaving, a flexible printed board was stacked on the upper surface of the anisotropic conductive paste layer such that the electrodes faced each other.

(3) Production of Second Connection Structure (L/S=75 μm/75 μm)

A glass epoxy board (FR-4 substrate) (first connection object member) having on its upper surface a copper electrode pattern (copper electrode thickness: 12 μm) having L/S of 75 μm/75 μm and an electrode length of 3 mm was prepared. In addition, a flexible printed board (second connection object member) having on its lower surface a copper electrode pattern (copper electrode thickness: 12 μm) having L/S of 75 μm/75 μm and an electrode length of 3 mm was prepared.

A second connection structure under the conditions A and B was obtained in the same manner as in the production of the first connection structure, except that the glass epoxy board and the flexible printed board differing in L/S were used.

(4) Production of Third Connection Structure (L/S=100 μm/100 μm)

A glass epoxy board (FR-4 substrate) (first connection object member) having on its upper surface a copper electrode pattern (copper electrode thickness: 12 μm) having L/S of 100 μm/100 μm and an electrode length of 3 mm was prepared. In addition, a flexible printed board (second connection object member) having on its lower surface a copper electrode pattern (copper electrode thickness: 12 μm) having L/S of 100 μm/100 μm and an electrode length of 3 mm was prepared.

A third connection structure under the conditions A and B was obtained in the same manner as in the production of the first connection structure, except that the glass epoxy board and the flexible printed board differing in L/S were used.

(Evaluation)

(1) Viscosity increase rate (η2/η1)

The viscosity (η1) at 25° C. of the anisotropic conductive paste immediately after production was measured. The anisotropic conductive paste immediately after production was left at room temperature for 24 hours, and the viscosity (η2) at 25° C. of the anisotropic conductive paste after leaving was measured. The viscosity was measured under condition of 25° C. and 5 rpm, using an E-type viscometer (“TVE22L” manufactured by Toki Sangyo Co., Ltd.). The viscosity increase rate (η2/η1) was calculated from the viscosity measurement value. The viscosity increase rate (η2/η1) was assessed according to the following criteria.

[Assessment criteria for viscosity increase rate (η2/η1)]
◯: The viscosity increase rate (η2/η1) is 2 or less
x: The viscosity increase rate (η2/η1) is more than 2

(2) Thickness of Solder Portion

The thickness of the solder portion between which the upper and lower electrodes were located was evaluated by observing the cross section of the obtained first connection structure.

(3) Placement Accuracy of Solder on Electrode

In the obtained first, second, and third connection structures, when viewing a portion where the first electrode and the second electrode faced each other in the stacking direction of the first electrode, the connection portion and the second electrode, a ratio X of an area where the solder portion in the connection portion was placed relative to 100% of the area of the portion where the first electrode and the second electrode faced each other was evaluated. The placement accuracy of the solder on the electrode was judged according to the following criteria.

[Assessment Criteria for Placement Accuracy of Solder on Electrode]
◯◯: The ratio X is 70% or more
◯: The ratio X is 60% or more and less than 70%
Δ: The ratio X is 50% or more and less than 60%
x: The ratio X is less than 50%

(4) Conduction Reliability Between Upper and Lower Electrodes

In the obtained first, second, and third connection structures (n=15), each connection resistance per connecting place between upper and lower electrodes was measured by a four-terminal method. An average value of the connection resistance was calculated. From the relationship of voltage=current×resistance, the connection resistance can be obtained by measuring the voltage when a constant current flows. The conduction reliability was judged according to the following criteria.

[Assessment Criteria for Conduction Reliability]
◯◯: The average value of connection resistances is 50 mΩ or less
◯: The average value of connection resistances is more than 50 mΩ and 70 mΩ or less
Δ: The average value of connection resistances is more than 70 mΩ and 100 mΩ or less
x: The average value of connection resistances is more than 100 mΩ, or a connection failure occurs

(5) Insulation Reliability Between Horizontally Adjacent Electrodes

The obtained first, second, and third connection structures (n=15) were left for 100 hours in an atmosphere of 85° C. and a humidity of 85%, 5 V was applied between horizontally adjacent electrodes, and the resistance value was measured at 25 places. The insulation reliability was assessed according to the following criteria.

[Assessment Criteria for Insulation Reliability]
◯◯: The average value of connection resistance is 10⁷Ω or more
◯: The average value of connection resistances is 10⁶Ω or more and less than 10⁷Ω
Δ: The average value of connection resistances is 10⁵Ω or more and less than 10⁶Ω
x: The average value of connection resistances is less than 10⁵Ω

(6) Positional Displacement Between Upper and Lower Electrodes

In the obtained first, second, and third connection structures, when viewing a portion where the first electrode and the second electrode faced each other in the stacking direction of the first electrode, the connection portion and the second electrode, whether the center line of the first electrode and the center line of the second electrode were aligned or not was observed, and a distance of the positional displacement was evaluated. The positional displacement between the upper and lower electrodes was assessed according to the following criteria.

[Assessment Criteria for Positional Displacement Between Upper and Lower Electrodes]
◯◯: The positional displacement is less than 15 μm
◯: The positional displacement is 15 μm or more and less than 25 μm
Δ: The positional displacement is 25 μm or more and less than 40 μm
x: The positional displacement is 40 μm or more

(7) Discoloration of Conductive Material

In the obtained first, second, and third connection structures, whether the connection portion of each connection structure was discolored or not was observed with a microscope, and discoloration of the conductive material was evaluated. The discoloration of the conductive material was assessed according to the following criteria.

[Assessment Criteria for Discoloration of Conductive Material]
◯: The connection portion is not discolored
x: The connection portion is discolored

The results are shown in the following Table 1.

TABLE 1

| | | | | | | | Comparative | Comparative | Comparative |
|---|---|---|---|---|---|---|---|---|---|
| | | | Example | Example | Example | Example | Example | Example | Example |
| | | | 1 | 2 | 3 | 4 | 1 | 2 | 3 |
| Compounded | Thermosetting | D.E.N-431 | 26.6 | 26.6 | 26.6 | | 26.6 | 14.8 | 18 |
| component | compound | jER152 | | | | 26.6 | | | |
| (part(s) by | Boron trifluoride | BF3-MEA | 0.3 | | | 0.3 | | | |
| weight) | complex | BF3-PIP | | 0.3 | | | | | |
| | | BF3-TEA | | | 0.3 | | | | |
| | Thermosetting agent | TMTP | | | | | | 11.8 | |
| | | HN-5500 | | | | | | | 8.6 |
| | Imidazole compound | 2PZ-CN | | | | | 0.3 | | 0.3 |
| | | 2E4MZ | | | | | | 0.3 | |
| | Flux | Salt of glutaric acid | 4.8 | 4.8 | 4.8 | 4.8 | 4.8 | 4.8 | 4.8 |
| | | and benzylamine | | | | | | | |
| | Conductive particle | Solder particle | 68.4 | 68.4 | 68.4 | 68.4 | 68.4 | 68.4 | 68.9 |
| | | Sn42Bi58 | | | | | | | |

| Type of conductive material | | Paste | Paste | Paste | Paste | Paste | Paste | Paste |
|---|---|---|---|---|---|---|---|---|
| Presence/absence of pressurization during heating | | absence | absence | absence | absence | absence | absence | absence |
| of conductive material layer | | | | | | | | |
| (Evaluation) | (1) Viscosity increase rate | ∘ | ∘ | ∘ | ∘ | ∘ | x | x |
| Evaluation | (2) Thickness of solder portion (μm) | 85 | 85 | 85 | 85 | 85 | 80 | 80 |
| (condition A) | (3) Placement accuracy | ∘∘ | ∘∘ | ∘∘ | ∘∘ | ∘∘ | ∘∘ | ∘ |
| | (first connection structure, L/S = | | | | | | | |
| | 50 μm/50 μm) | | | | | | | |
| | (3) Placement accuracy | ∘∘ | ∘∘ | ∘∘ | ∘∘ | ∘∘ | ∘∘ | ∘ |
| | (second connection structure, L/S = | | | | | | | |
| | 75 μm/75 μm) | | | | | | | |
| | (3) Placement accuracy | ∘∘ | ∘∘ | ∘∘ | ∘∘ | ∘∘ | ∘∘ | ∘ |
| | (third connection structure, L/S = | | | | | | | |
| | 100 μm/100 μm) | | | | | | | |
| | (4) Conduction reliability | ∘∘ | ∘∘ | ∘∘ | ∘∘ | ∘∘ | ∘∘ | ∘ |
| | (first connection structure, L/S = | | | | | | | |
| | 50 μm/50 μm) | | | | | | | |
| | (4) Conduction reliability | ∘∘ | ∘∘ | ∘∘ | ∘∘ | ∘∘ | ∘∘ | ∘ |
| | (second connection structure, L/S = | | | | | | | |
| | 75 μm/75 μm) | | | | | | | |
| | (4) Conduction reliability | ∘∘ | ∘∘ | ∘∘ | ∘∘ | ∘∘ | ∘∘ | ∘ |
| | (third connection structure, L/S = | | | | | | | |
| | 100 μm/100 μm) | | | | | | | |
| | (5) Insulation reliability | ∘ | ∘ | ∘ | ∘ | ∘ | ∘ | Δ |
| | (first connection structure, L/S = | | | | | | | |
| | 50 μm/50 μm) | | | | | | | |
| | (5) Insulation reliability | ∘ | ∘ | ∘ | ∘ | ∘ | ∘ | Δ |
| | (second connection structure, L/S = | | | | | | | |
| | 75 μm/75 μm) | | | | | | | |
| | (5) Insulation reliability | ∘ | ∘ | ∘ | ∘ | ∘ | ∘ | Δ |
| | (third connection structure, L/S = | | | | | | | |
| | 100 μm/100 μm) | | | | | | | |
| | (6) Positional displacement | ∘ | ∘ | ∘ | ∘ | ∘ | ∘ | Δ |
| | (first connection structure, L/S = | | | | | | | |
| | 50 μm/50 μm) | | | | | | | |
| | (6) Positional displacement | ∘ | ∘ | ∘ | ∘ | ∘ | ∘ | Δ |
| | (second connection structure, L/S = | | | | | | | |
| | 75 μm/75 μm) | | | | | | | |
| | (6) Positional displacement | ∘ | ∘ | ∘ | ∘ | ∘ | ∘ | Δ |
| | (third connection structure, L/S = | | | | | | | |
| | 100 μm/100 μm) | | | | | | | |
| | (7) Discoloration of conductive material | ∘ | ∘ | ∘ | ∘ | x | x | x |
| | (first connection structure, L/S = | | | | | | | |
| | 50 μm/50 μm) | | | | | | | |
| | (7) Discoloration of conductive material | ∘ | ∘ | ∘ | ∘ | x | x | x |
| | (second connection structure, L/S = | | | | | | | |
| | 75 μm/75 μm) | | | | | | | |
| | (7) Discoloration of conductive material | ∘ | ∘ | ∘ | ∘ | x | x | x |
| | (third connection structure, L/S = | | | | | | | |
| | 100 μm/100 μm) | | | | | | | |
| Evaluation | (2) Thickness of solder portion (μm) | 85 | 85 | 85 | 85 | 85 | 85 | 85 |
| (condition B) | (3) Placement accuracy | ∘∘ | ∘∘ | ∘∘ | ∘∘ | ∘∘ | ∘ | Δ |
| | (first connection structure, L/S = | | | | | | | |
| | 50 μm/50 μm) | | | | | | | |
| | (3) Placement accuracy | ∘∘ | ∘∘ | ∘∘ | ∘∘ | ∘∘ | ∘ | Δ |
| | (second connection structure, L/S = | | | | | | | |
| | 75 μm/75 μm) | | | | | | | |
| | (3) Placement accuracy | ∘∘ | ∘∘ | ∘∘ | ∘∘ | ∘∘ | ∘ | Δ |
| | (third connection structure, L/S = | | | | | | | |
| | 100 μm/100 μm) | | | | | | | |
| | (4) Conduction reliability | ∘∘ | ∘∘ | ∘∘ | ∘∘ | ∘∘ | ∘ | Δ |
| | (first connection structure, L/S = | | | | | | | |
| | 50 μm/50 μm) | | | | | | | |
| | (4) Conduction reliability | ∘∘ | ∘∘ | ∘∘ | ∘∘ | ∘∘ | ∘ | Δ |
| | (second connection structure, L/S = | | | | | | | |
| | 75 μm/75 μm) | | | | | | | |
| | (4) Conduction reliability | ∘∘ | ∘∘ | ∘∘ | ∘∘ | ∘∘ | ∘ | Δ |
| | (third connection structure, L/S = | | | | | | | |
| | 100 μm/100 μm) | | | | | | | |
| | (5) Insulation reliability | ∘ | ∘ | ∘ | ∘ | ∘ | Δ | x |
| | (first connection structure, L/S = | | | | | | | |
| | 50 μm/50 μm) | | | | | | | |
| | (5) Insulation reliability | ∘ | ∘ | ∘ | ∘ | ∘ | Δ | x |
| | (second connection structure, L/S = | | | | | | | |
| | 75 μm/75 μm) | | | | | | | |
| | (5) Insulation reliability | ∘ | ∘ | ∘ | ∘ | ∘ | Δ | x |
| | (third connection structure, L/S = | | | | | | | |
| | 100 μm/100 μm) | | | | | | | |
| | (6) Positional displacement | ∘ | ∘ | ∘ | ∘ | ∘ | Δ | x |
| | (first connection structure, L/S = | | | | | | | |
| | 50 μm/50 μm) | | | | | | | |
| | (6) Positional displacement | ∘ | ∘ | ∘ | ∘ | ∘ | Δ | x |
| | (second connection structure, L/S = | | | | | | | |
| | 75 μm/75 μm) | | | | | | | |
| | (6) Positional displacement | ∘ | ∘ | ∘ | ∘ | ∘ | Δ | x |
| | (third connection structure, L/S = | | | | | | | |
| | 100 μm/100 μm) | | | | | | | |
| | (7) Discoloration of conductive material | ∘ | ∘ | ∘ | ∘ | x | x | x |
| | (first connection structure, L/S = | | | | | | | |
| | 50 μm/50 μm) | | | | | | | |
| | (7) Discoloration of conductive material | ∘ | ∘ | ∘ | ∘ | x | x | x |
| | (second connection structure, L/S = | | | | | | | |
| | 75 μm/75 μm) | | | | | | | |
| | (7) Discoloration of conductive material | ∘ | ∘ | ∘ | ∘ | x | x | x |
| | (third connection structure, L/S= | | | | | | | |
| | 100 μm/100 μm) | | | | | | | |

The same tendency was observed even when a resin film, a flexible flat cable and a rigid flexible substrate were used instead of a flexible printed board.

### EXPLANATION OF SYMBOLS

1, 1X: Connection structure
2: First connection object member
2a: First electrode
3: Second connection object member
3a: Second electrode
4, 4X: Connection portion
4A, 4XA: Solder portion
4B, 4XB: Cured product portion
11: Conductive material
11A: Solder particles (conductive particles)
11B: Thermosetting component
21: Conductive particles (solder particles)
31: Conductive particles
32: Base particles
33: Conductive portion (conductive portion with solder)
33A: Second conductive portion
33B: Solder portion
41: Conductive particles
42: Solder portion

1. A conductive material comprising a plurality of conductive particles having solder at an outer surface portion of a conductive portion, a curable compound, and a boron trifluoride complex.

2. The conductive material according to claim 1, wherein the boron trifluoride complex is a boron trifluoride-amine complex.

3. The conductive material according to claim 1, wherein the content of the boron trifluoride complex in 100% by weight of the conductive material is 0.1% by weight or more and 1.5% by weight or less.

4. The conductive material according to claim 1, wherein the viscosity at 25° C. is 50 Pa·s or more and 500 Pa·s or less.

5. The conductive material according to claim 1, wherein the average particle diameter of the conductive particles is 0.5 m or more and 100 μm or less.

6. The conductive material according to claim 1, wherein the content of the conductive particles in 100% by weight of the conductive material is 30% by weight or more and 95% by weight or less.

7. The conductive material according to claim 1, which is a conductive paste.

8. A connection structure comprising:
a first connection object member having at least one first electrode on its surface;
a second connection object member having at least one second electrode on its surface; and
a connection portion connecting the first connection object member and the second connection object member,
the connection portion including the conductive material according to claim 1, and
the first electrode and the second electrode being electrically connected by a solder portion in the connection portion.

9. The connection structure according to claim 8, wherein, when viewing a portion where the first electrode and the second electrode face each other in a stacking direction of the first electrode, the connection portion, and the second electrode, the solder portion in the connection portion is placed in 50% or more of 100% of the area of the portion where the first electrode and the second electrode face each other.

10. A method for producing a connection structure, comprising:
placing the conductive material according to claim 1 on a surface of a first connection object member, having at least one first electrode on its surface, with the use of the conductive material;
disposing a second connection object member, having at least one second electrode on its surface, on a surface opposite to the first connection object member side of the conductive material such that the first electrode and the second electrode face each other; and
heating the conductive material to a temperature not lower than a melting point of solder of the conductive particles to form a connection portion, connecting the first connection object member and the second connection object member, with the conductive material and electrically connecting the first electrode and the second electrode via a solder portion in the connection portion.

11. The method for producing a connection structure according to claim 10, wherein, when viewing a portion where the first electrode and the second electrode face each other in a stacking direction of the first electrode, the connection portion, and the second electrode, the solder portion in the connection portion is placed in 50% or more of 100% of the area of the portion where the first electrode and the second electrode face each other.
